(19) United States
(12) Patent Application Publication
(10) Pub. No.: US 2008/0163342 A1
(43) Pub. Date: Jul. 3, 2008

(54) System and method for managing information relating to end-of-life issues

(76) Inventor: David L. Christopherson, Plymouth, MN (US)

Correspondence Address: MERCHANT & GOULD PC, P.O. BOX 2903, MINNEAPOLIS, MN, 55402-0903, US

(21) Appl. No.: 11/999,390

(22) Filed: Dec. 4, 2007

Related U.S. Application Data
(60) Provisional application No. 60/868,475, filed on Dec. 4, 2006.

(51) Int. Cl. H04L 9/32; G06F 3/048

(52) U.S. Cl. 726/4; 715/709

(57) ABSTRACT

A system and method for securely and centrally storing, updating, and transferring information pertaining to the end-of-life issues of an administrator is described. The information can be input into the system by an administrator or by the administrator's representative. The information is input and stored within topical folders and sub-folders, making the information easy to locate again in the future by the representative.

### CROSS REFERENCE TO RELATED APPLICATIONS

This application claims priority to U.S. Provisional Application Ser. No. 60/868,475, filed on Dec. 4, 2006, entitled SYSTEM AND METHOD FOR MANAGING INFORMATION RELATING TO END-OF-LIFE ISSUES, the disclosure of which is incorporated by reference herein in its entirety.

### TECHNICAL FIELD

The present disclosure relates to data management, and more particularly to a system and method for managing information relating to end-of-life issues.

### BACKGROUND

A family member who is involved in the end-of-life issues of a loved one faces a tremendous burden of gathering and locating all of the information needed to resolve those issues. Not only will the family member need to know identification information and the loved one's desired disposition of personal property but also a vast array of additional information will need to be gathered. This information includes, for example, bank account information, the location of and method of accessing a safety-deposit box, what real and personal property was owned, the location of appropriate records for real and personal property, and much more.

For most people, this information is dispersed in a variety of locations, for example, in a file cabinet, in a desk drawer, with the person's lawyer, or in a personal journal or other records. Even more troublesome, much of the information may be stored only in the memory of the individual, and thereby lost when the person dies or becomes incapacitated.

### SUMMARY

A system and method for securely and centrally storing information pertaining to the end-of-life issues of an administrator is described. The information can be input into the system by an administrator or by the administrator's representative. The information is input and stored within topical folders and sub-folders, making the information easy to locate again in the future by the representative.

One aspect is a system for managing information relating to end-of-life issues of an administrator, the system comprising a computer readable storage medium; a product key code associated with the computer readable storage medium, the product key code including alphanumeric characters; and packaging containing the computer readable storage medium and the product key code, the packaging obscuring the product key code from view until the packaging is opened. The computer readable storage medium stores computer-executable instructions which when executed by a computer cause the computer to perform a method of managing information relating to end-of-life issues. The method comprises receiving the product key code; communicating across a network with a server to validate the product key code; unlocking features of the computer-executable instructions after validating; prompting for and receiving end-of-life information after unlocking; and storing the end-of-life information after receiving.

There is no requirement that an arrangement include all features characterized herein to obtain some advantage according to the present disclosure.

### BRIEF DESCRIPTION OF THE DRAWINGS

FIG. 1 is a block diagram of an example system according to the present disclosure.

FIG. 2 is a flow chart and timeline illustrating an example method of using the system illustrated in FIG. 1.

FIG. 3 is a screen shot of an example user interface for an installer.

FIG. 4 is another screen shot of an example user interface for the installer of FIG. 3.

FIG. 5. is a flow chart illustrating an example of an operation during which software is unlocked.

FIG. 6 illustrates an example user interface for an operation during which the administrator is prompted for a product key for the operation shown in FIG. 5.

FIG. 7 is a flow chart illustrating an operation during which the product key of FIG. 6 is evaluated to ensure it is valid and has not expired.

FIG. 8 is a flow chart of an operation during which system-related information is displayed to the administrator.

FIG. 9 is a screen shot of an example web site as displayed to the administrator.

FIG. 10 is a flow chart illustrating an example method for opening an administrator drawer.

FIG. 11 is a screen shot of a user interface illustrating an operation during which the administrator is prompted to create a new drawer or open an existing drawer.

FIG. 12 is a screen shot of a user interface associated with operations for prompting the administrator for a drawer name and password to create a new drawer.

FIG. 13 is a screen shot illustrating one example of a user interface for managing information relating to the end-of-life issues of the administrator.

FIG. 14 is a flow chart illustrating a method in which the administrator enters data relating to end-of-life issues.

FIG. 15 is a flow chart illustrating a guided entry operation.

FIG. 16 is a screen shot of the user interface of FIG. 13 displaying an example topic summary.

FIG. 17 is a screen shot of the user interface of FIG. 13 performing an example operation to display topics selected in the topic summary of FIG. 16.

FIG. 18 is a screen shot of the user interface of FIG. 13 performing an example operation to display a second topic selected in the topic summary of FIG. 16.

FIG. 19 is a screen shot of the user interface of FIG. 13 performing an example operation to display a third topic selected in the topic summary of FIG. 16.

FIG. 20 is a screen shot of the user interface of FIG. 13 performing an example operation to display a fourth topic selected in the topic summary of FIG. 16.

FIG. 21 is a screen shot of the user interface of FIG. 13 illustrating an example information summary display.

FIG. 22 is a flow chart illustrating a manual entry operation.

FIG. 23 is a screen shot of the user interface of FIG. 13 illustrating operations of the manual entry operation of FIG. 22.

FIG. 24 is a screen shot of the user interface of FIG. 13 displaying an example page for the performance of an operation of the manual entry operation of FIG. 22.

FIG. 25 is a screen shot of the user interface of FIG. 13 having a property folder selected.

FIG. 26 is a screen shot of the user interface of FIG. 13 having an Autos sub-folder selected, and illustrating an example dynamic information box.

FIG. 27 is a screen shot of the user interface of FIG. 13 including a dynamic page.

FIG. 28 is a screen shot of the user interface of FIG. 13 including another dynamic page.

FIG. 29 is a screen shot of the user interface of FIG. 13 including another dynamic page.

FIG. 30 is a screen shot of the user interface of FIG. 13 including the dynamic information box of FIG. 26.

FIG. 31 is a screen shot of a user interface for an Identification folder and associated topics.

FIG. 32 is a screen shot of a user interface for a Family folder and associated topics.

FIG. 33 is a screen shot of a user interface for a Health Care folder and associated topics.

FIG. 34 is a screen shot of a user interface for a Funeral folder and associated topics.

FIG. 35 is a screen shot of a user interface for a Legal folder and associated topics.

FIG. 36 is a screen shot of a user interface for a Property folder and associated topics.

FIG. 37 is a screen shot of a user interface for a Financial folder and associated topics.

FIG. 38 is a screen shot of a user interface for an Insurance folder and associated topics.

FIG. 39 is a screen shot of a user interface for a Contacts folder and associated topics.

FIG. 40 is a screen shot of a user interface for a Business folder and associated topics.

FIG. 41 is a screen shot of a user interface performing an operation to move the software to another computer.

FIG. 42 is a screen shot of a user interface continuing the operation of FIG. 41.

FIG. 43 is a screen shot of a user interface continuing the operation of FIG. 41.

### DETAILED DESCRIPTION

An example system according to the present disclosure enables an administrator to proactively plan for the administrator's eventual demise, to pass on information that will be useful or valuable to a personal representative, such as a family member, friend, lawyer, or executor of the will, who will be involved in the resolution of the end-of-life issues of the administrator.

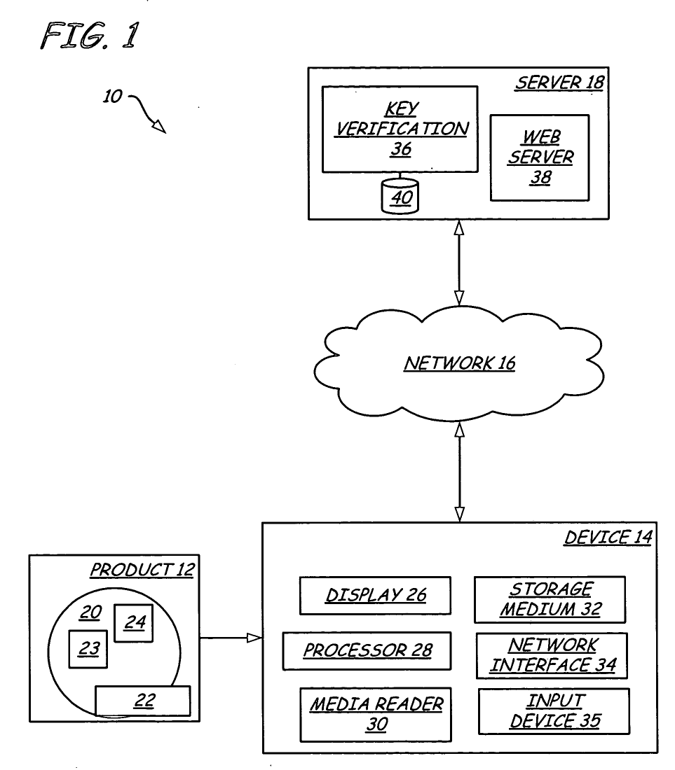

FIG. 1 is a block diagram of an example system 10 according to the present disclosure. System 10 includes product 12, device 14, network 16, and server 18. Product 12 includes computer-readable medium 20 and product key 22. Computer readable medium 20 includes installer 23 and software 24. Installer 23 contains instructions that cause device 14 to install software 24 onto itself, and also to unlock software 24 after installation. Software 24 contains instructions that cause device 14 to receive, store, and retrieve information pertaining to the end-of-life issues of the administrator. Computer readable medium 20 is a CD ROM. Alternatively, computer readable medium 20 is a floppy disc, flash drive, or any other computer readable medium. In another embodiment, software 24 is provided directly over network 16 to computer 14, such that computer readable medium 20 is unnecessary.

Product key 22 is, for example, a unique alpha-numeric code that is used by system 10 to verify that software 24 is a licensed copy. Product key 22 may also be numbers, letters, or any other combination of symbols that will form a unique code for verifying that software 24 is a licensed copy and that software 24 has not expired. In one example, product key 22 is coated with a scratch-off coating to obscure product key 22 from view until the scratch-off coating is removed, such as with a fingernail or a coin to reveal product key 22.

Device 14 is a personal computer. Alternatively, any other computing device may also be used, such as a personal digital assistant (PDA), hand-held computer, blackberry, cell phone, or any other device capable of executing software and providing a user-interface, such as a graphical user interface or an audible user interface. Device 14 includes display 26, processor 28, media reader 30, storage medium 32, network interface 34, and input device 35. Display 26 is a computer monitor. Alternatively, display 26 is any other type of device capable of conveying information to a user, such as a liquid crystal display, television, or speaker. Processor 28 is a central processing unit. Alternatively, processor 28 is any processor or microprocessor capable of executing software. Media reader 30 is a CD ROM drive. Alternatively, media reader 30 is any other type of media reader, such as a floppy disc drive, flash drive, external hard disc drive, or any other device capable of reading computer readable medium 20. Storage medium 32 is a hard disc drive that stores software 24 after installation as well as information pertaining to the end-of-life issues of the administrator. Alternatively, storage medium 32 is any other type of storage medium capable of storing software 24 and information pertaining to end-of-life issues, such as a memory device or a remote computer system. Network interface 34 is a modem capable of sending and receiving data across network 16. Input device 35 is a keyboard and a mouse. Alternatively, a touch pad, touch screen, voice-recognition system, or any other device for obtaining input from a user may be used. All input received from the administrator or personal representative is received through input device 35.

Network 16 is a communication network such as the Internet. However, other networks such as a local area network (LAN), wide area network (WAN), wireless network, a telephone system, or other communication network could also be used. Network 16 enables data communication between device 14 and server 18.

Server 18 is one or more computers in communication with network 16 so as to be capable of communication with device 14. Server 18 includes key verification system 36 and web server 38. Key verification system 36 includes a database 40 of all valid product keys, and whether or not the key has been previously used. Web server 38 hosts a web site that is accessible by device 14 across network 16. The web site is used to convey useful information to a user of device 14. For example, the web site can be used to purchase product 12, or to download software 24 directly. In addition, helpful information such as an exhaustive glossary of end-of-life terminology, technical support information, and company contact information may also be provided by web server 38.

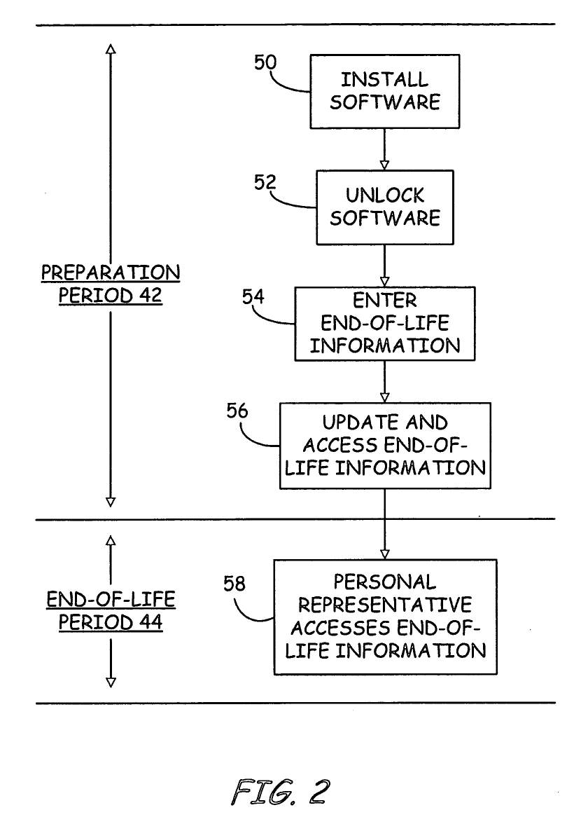

FIG. 2 is a flow chart and timeline illustrating a method of using system 10. There are two general stages of system use. The first stage is preparation period 42. During preparation period 42, the administrator interacts with system 10 to install, enter, and maintain information relating to end-of-life issues. The second stage is end-of-life period 44. During end-of-life period 44, the representative interacts with system 10 to access the stored information to assist the representative in performing tasks relating to end-of-life issues.

Preparation period 42 includes operation 50 during which software is installed, operation 52 during which the software is unlocked, operation 54 during which end-of-life information is entered, and operation 56 during which end-of-life information is updated and accessed by the administrator. End-of-life period 44 includes operation 58 during which the personal representative accesses the end-of-life information. Each of the operations illustrated in FIG. 2 is described in more detail below with reference to the illustrated embodiment.

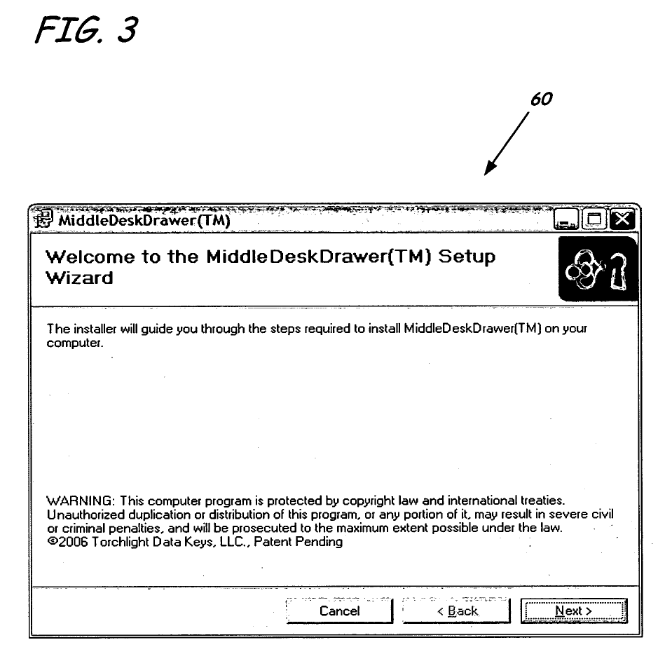

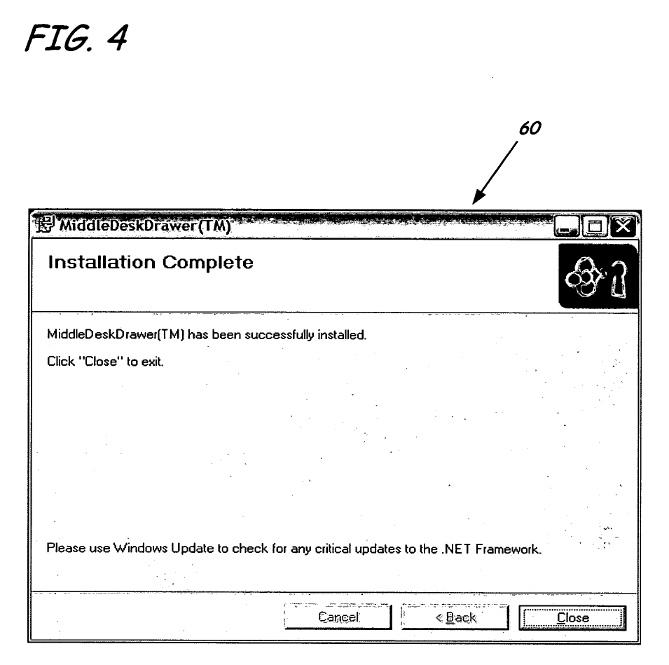

FIGS. 3-4 illustrate one example of operation 50, during which software is installed from product 12 to device 14. Computer readable medium 20 is read by device 14, such as by inserting a CD ROM into a CD ROM drive. Device 14 then reads and executes installer 23.

FIG. 3 is a screen shot of example user interface 60 of installer 23, as displayed by display 26 on device 14. Installer 23 is a software program that guides the administrator in installing software 24 onto device 14. Installer 23 is, for example, a computer wizard. Installer 23 prompts the administrator though user interface 60 to answer a number of questions that instruct installer 23 of how the administrator desires to have the software installed onto device 14. For example, installer 23 first asks the administrator to select a directory for installer 23 to install software 24 onto the storage medium of device 14. In addition, installer 23 can display on user interface 60 the amount of disc space available, and the amount of disc space that will be required by software 24. Installer 23 then displays on user interface 60 a license agreement to the administrator and asks the administrator whether he agrees to the terms of the agreement. If not, installer 23 ends the installation process without installing software 24. If the administrator agrees, then software 24 is installed into the appropriate directory of device 14, such as by copying software 24 to storage medium 32 and defining links to software 24, such as by installing an icon on the computer operating system desktop or inserting the software name into a program listing in the operating system. Alternatively, any other desired installation configuration options can be provided to the administrator via user interface 60, such as to personalize the installation of software 24.

FIG. 4 is a screen shot of example user interface 60 of installer 23. After installation has been completed, installer 23 provides a confirmation message to the administrator through user interface 60 showing that the installation has been completed successfully. Although software 24 is installed, it remains locked and inoperable until unlocked by key server 18.

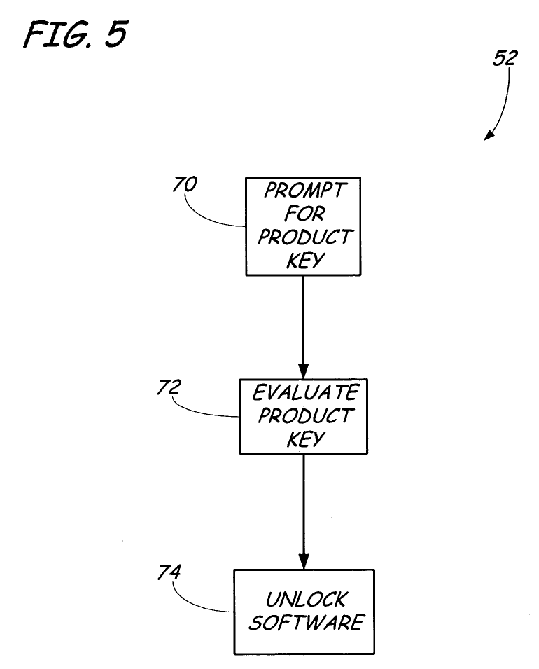

FIGS. 5-7 illustrate operation 52 (shown in FIG. 2) during which software 24 is unlocked using product key 22. FIG. 5. is a flow chart illustrating an example of operation 52, during which software 24 is unlocked. Operation 52 includes operation 70 during which a product key is requested, operation 72 during which the product key is evaluated, and operation 74 during which the software is unlocked if the evaluation reveals that the product key is valid and has not expired.

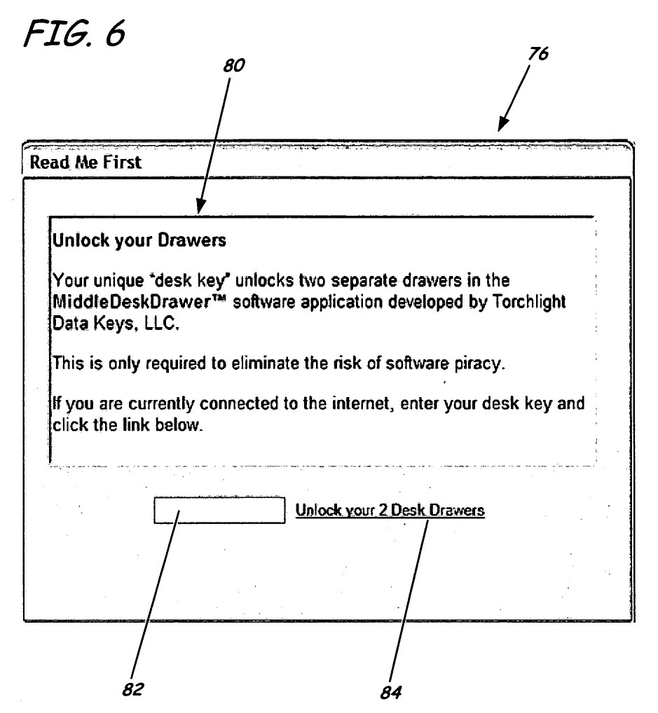

FIG. 6 illustrates example user interface 76 used in operation 70. The administrator is prompted by user interface 76 to enter product key 22 in order to ensure that software 24 is a licensed copy that has not expired. Operation 70 includes the display of unlock message 80 on user interface 76, key entry field 82, and key submission button 84. Unlock message 80 explains why product key 22 needs to be entered, and requests that the administrator do so. Key entry field 82 is a field in which the administrator can enter product key 22. Key submission button 84 is a button that will submit the product key entered into field 82.

When presented with the request for product key 22, such as shown in FIG. 6, the administrator is asked to locate product key 22, such as located on product 12 (shown in FIG. 1). Product key 22 is then entered into field 82, after which the administrator selects key submission button 84, such as by hitting <ENTER> or clicking key submission button 84 with a pointer, such as with a mouse or other input device.

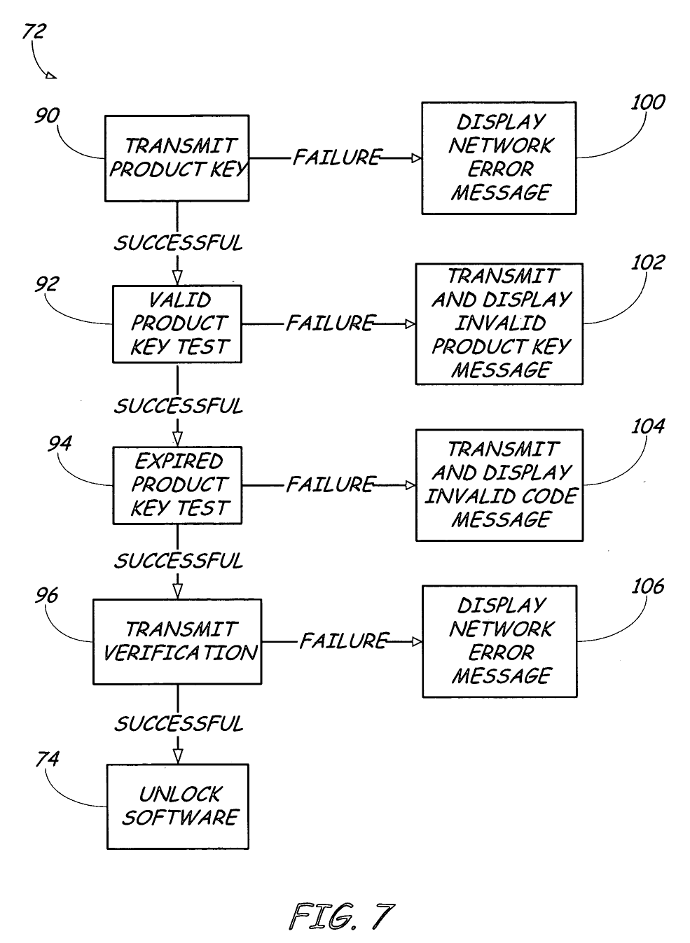

FIG. 7 is a flow chart illustrating operation 72 during which product key 22 is evaluated to ensure that it is valid and has not expired. Operation 72 includes operation 90 during which product key 22 is transmitted, operation 92 during which a valid product key test is performed, operation 94 during which an expired product key test is performed, and operation 96 during which a verification is transmitted. If any of operations 90, 92, 94, or 96 fails to complete successfully, corresponding operations 100, 102, 104, or 106 are performed to display an appropriate error message on user interface 76. Following the successful completion of operation 96 is operation 74 during which software 24 on device 14 is unlocked.

After the administrator selects the key submission button (e.g., 84 shown in FIG. 6), operation 72 is performed to evaluate the product key. Operation 72 begins with operation 90 during which the entered product key (e.g., the key entered by the administrator into key entry field 82) is transmitted from device 14 to server 18 via network 16. This transmission can occur by any standard method of data transmission across a network, such as hypertext transfer protocol (HTTP), secure socket layer (SSL), or any of the many other known methods of data transmission across a network. If operation 90 is unsuccessful, such as if a connection between device 14 and network 16 is not present, operation 100 is performed to display an appropriate error message to the administrator on user interface 70.

Following the successful completion of operation 90, operation 92 is performed during which a valid product key test is performed. In operation 90, key verification system 36 receives the transmitted product key from device 14, and evaluates the product key to determine whether the product key is valid. For example, key verification system 36 compares the received product key with a list of valid product keys stored in database 40. The list of valid product keys includes all product keys (e.g., 22 shown in FIG. 1) that have been included on all products (e.g., 12 shown in FIG. 1). If the received product key matches one of the product keys stored in database 40 then the valid product key test of operation 92 is completed successfully. If no match is found, the received product key is determined to be invalid and an appropriate message is transmitted and displayed to the administrator on user interface 76, informing the administrator that the product key is invalid. The administrator can then try again by re-entering the product key or the administrator can cancel operation 72, in which case software 24 remains locked and inoperable.

If operation 92 completes successfully, operation 94 is then performed during which an expired product key test is performed. The purpose of operation 94 is to evaluate product key 22 to determine whether the product key has expired. A product key will not typically expire due to a lapse of time, but rather a product key expires after use. For example, server 18 can ensure that only a single copy of software 24 can be used, such as to enforce the license agreement agreed to during the installation of software 24 performed in operation 50 (shown in FIG. 2).

The expired product key test of operation 94 evaluates the product key, for example, by comparing the product key to a list of used product keys stored in database 40. If the product key is not found in the list of used product keys, key verification system 36 determines that the product key has not expired and the test is completed successfully. If the product key is found, however, key verification system 36 determines that the product key has expired, and therefore transmits and displays an invalid product key message to the administrator in operation 104.

Following the successful completion of operation 94, operation 96 is performed to transmit a verification message to device 14. During operation 96 a message is transmitted from key verification system 36 that informs installer 23 that the entered product key is valid and that software 24 on device 14 should be unlocked. The message may be any predefined code or instruction. If operation 96 fails, such as due to a lost connection with network 16, operation 106 displays an error message to the administrator informing of the network error. Upon successful completion of operation 94, product key 22 is added to the list of used product keys stored in database 40 to prevent reuse of the product key. Operation 74 is then performed during which software 24 is unlocked on device 14 by installer 23 to enable all features of software 24.

After installation and unlocking of software 24 has been completed, product 12 can be discarded because all necessary information is now stored on device 14. The installation and unlocking operations need not be repeated after the first installation. Backup copies of software 24 can be made by the administrator, if desired, to avoid data loss should device 14 fail. In addition, should the administrator desire to transfer software 24 to a different device, software 24 can be copied to the new device and uninstalled from device 14.

For example, if an administrator wishes to transfer software 24 from device 14 to another device, software 24 can be programmed to include an automated process such as a wizard to facilitate the transfer. The process can include operations that prompt the user to copy the software and data files to another device. This can be done, for example, by connecting removable media to device 14 (e.g., a memory stick or other similar device), and then copying relevant data and software 24 to the removable media. All of this must be done while device 14 is connected to the Internet. During the uninstall process, the system displays the original product key, and prompts the user to make note of it. In addition, the system transmits a message to key verification system 36, requesting that the product key be made re-available for use. The removable media can then be disconnected from device 14 and connected to the target device. Software 24 and related data can then be installed on the target device. As part of the installation process, the system asks the administrator to enter the original product key that has been made re-available. The product key is evaluated, as described above, to confirm that the product key is valid and has not expired. If the product key evaluation is successful, software 24 is then unlocked, such that the administrator again has full access to all of his stored information on the new device. In this manner, transfer of software 24 and relevant data can be accomplished without requiring referral to or reuse of product 12.

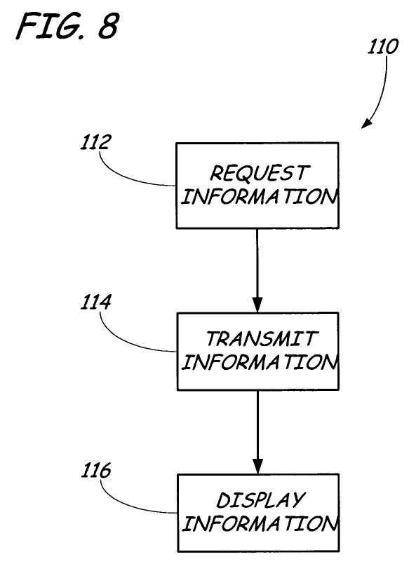

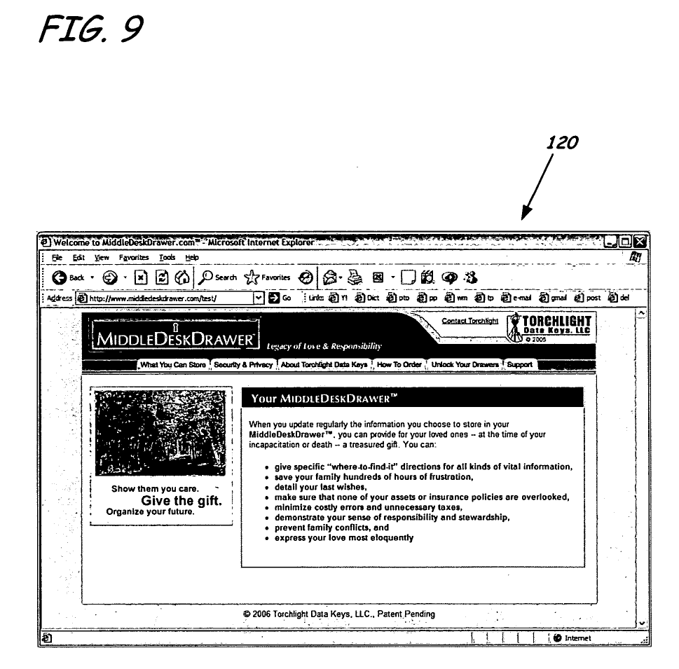

FIGS. 8-9 illustrate an optional method of displaying additional information to the administrator, such as through the display of information from web server 38.

FIG. 8 is a flow chart of operation 110 during which system-related information is displayed to the administrator. Operation 110 includes operation 112 during which an information request is made, operation 114 during which information is transmitted, and operation 116 during which information is displayed.

During operation 112, a request is made from device 14 to web server 38. The request can be made through a web browser operating on device 14, which transmits an HTTP request to web server 38. Web server 38 receives the request and provides the requested information in the form of a web site to device 14 in operation 114. The web site contains information relating to software 24, such as a list of features and benefits, instructions on purchasing additional copies of software 24, and instructions for contacting the manufacturer. In addition, information relating to end-of-life issues can also be provided on the web site, such as a glossary of terms relating to end-of-life issues and other instructional information. The web site is then received by device 14 and displayed to the administrator in operation 116, such as through the web browser.

FIG. 9 is a screen shot of an example web site 120 as displayed to the administrator. Web site 120 is generated and transmitted by web server 38 as described above. Web site 120 can include a plurality of web pages that present information relating to software 24 and end-of-life issues generally. In addition, web site 120 can be used to interact with device 14, such as to initially download installer 23 and software 24 from server 18 to device 14.

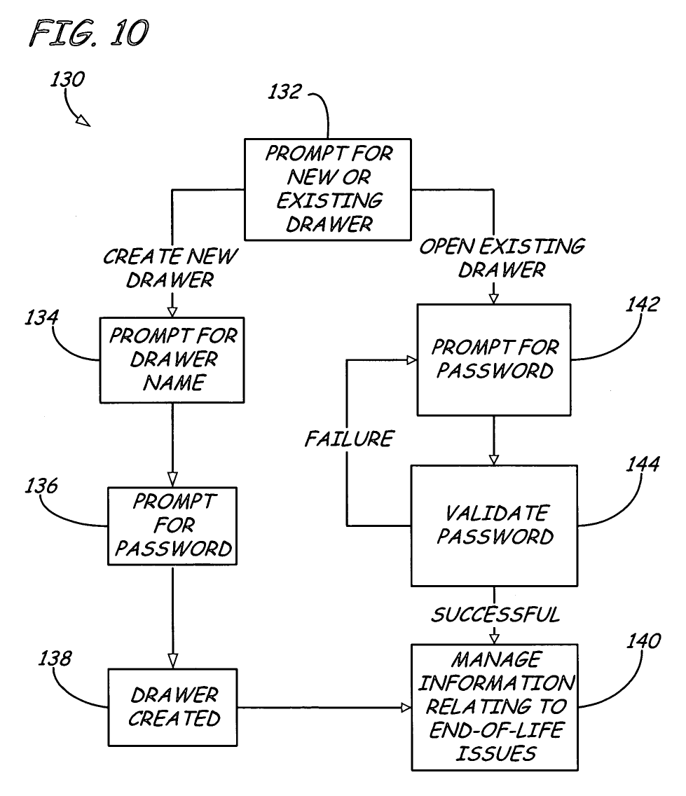

FIGS. 10-12 illustrate a method of opening an administrator's drawer in preparation for entering and managing information relating to the end-of-life issues of the administrator.

FIG. 10 is a flow chart illustrating an example method 130 for opening an administrator's drawer. In example embodiments, each administrator has his or her own drawer for the storage of information relating to his or her own end-of-life issues. In other words, each drawer can be personalized to the individual administrator. In one example, software 24 allows for two drawers, such as for a husband and wife. More or fewer drawers can be provided. In one arrangement, the data associated with each drawer is maintained separately, so that data that is entered for a particular drawer is not shared with any other drawers. In other arrangements, data can be shared between drawers as desired. For example, data can be exported and imported between drawers if a husband and wife share common information such as residence. In this manner, data entry time can be minimized.

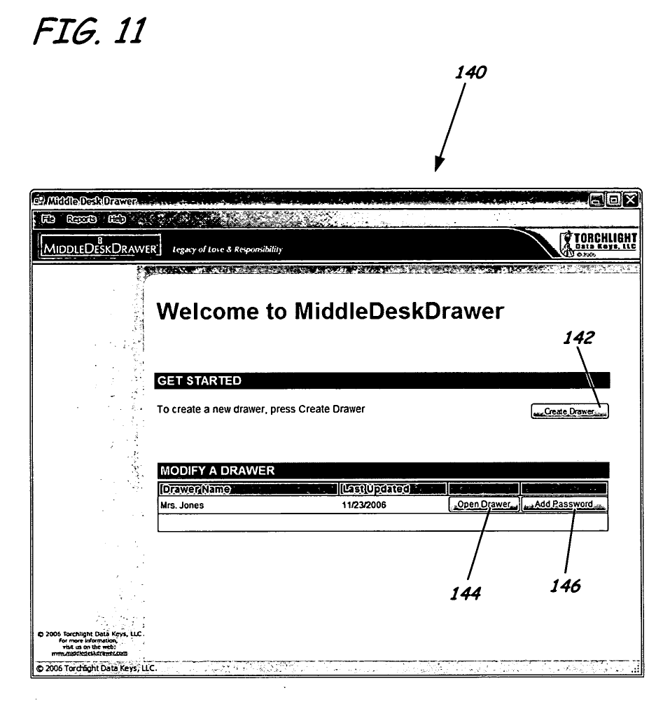

Method 130 begins with operation 132 during which the administrator is prompted to either create a new drawer or to open an existing drawer. (An example screen shot illustrating operation 132 is described below with reference to FIG. 11.) At operation 132, the administrator is queried as to whether the administrator has previously created a drawer, or whether this is the first time that the administrator has used the system. If it is the first time, the administrator selects “create a new drawer.” Operation 134 is then performed, in which the administrator is prompted to enter a drawer name. The drawer name can be any alpha-numeric code, such as the name of the administrator. The administrator is then prompted to enter a password, if desired, in operation 136. The password is then stored on storage medium 32 and associated with the administrator's drawer. In one example the password is encrypted to prevent unauthorized access to the password.

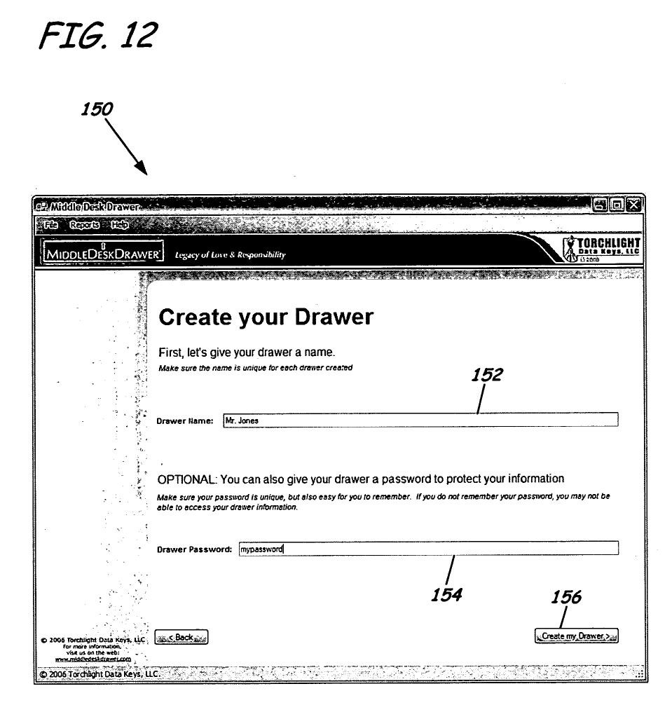

The password can be associated with the drawer to ensure that only authorized users of device 14 can access information stored within the administrator's drawer. However, if the administrator chooses to leave this field blank, the drawer will be accessible to any user that desires to access the drawer on device 14. (An example screen shot illustrating operations 134 and 136 is shown in FIG. 12 and described below.)

After entering a drawer name and password, operation 138 is performed to create the requested drawer for the administrator. The process of creating a drawer involves storing files in storage medium 32 associated with the drawer name and password, into which all end-of-life information relating to the administrator will be stored. The data stored in storage medium 32 is encrypted to protect the data from unauthorized access. Operation 140 is then performed in which the drawer is opened and the administrator is able to enter, review, delete, or otherwise manage information pertaining to the end-of-life issues of the administrator.

After the administrator has initially created a drawer, the drawer will then be stored and accessible to the administrator or the representative. In such a case, the administrator or representative will be prompted at operation 132 to either create a new drawer or access an existing drawer. Because the drawer has already been created, the option for accessing an existing drawer is selected (e.g., open existing drawer button 144 illustrated in FIG. 11) by the administrator.

Operation 142 is then performed, in which the administrator or representative is prompted to enter the password associated with the drawer, if one has been previously associated with the drawer. The administrator or representative enters the appropriate password. The password is then validated in operation 144. For example, the password that is entered is compared with the password that was previously entered by the administrator in operation 136. If the password is successfully validated, then operation 140 is performed. If the password is not validated, such that the password does not match that previously entered, operation 142 is repeated, such that the administrator or representative is again prompted for the password.

FIG. 11 is a screen shot of user interface 140 illustrating operation 132. User interface 140 includes create drawer button 142, open existing drawer button 144, and add password button 146. User interface 140 performs operation 132 in which the administrator is prompted to enter whether the administrator desires to create a new drawer or to access an existing drawer.

If the administrator desires to create a new drawer, the administrator selects create drawer button 142. If the administrator desires to access an existing drawer, the administrator selects open existing drawer button 144 associated with the proper drawer name. If more than one drawer has been created, multiple buttons 144 will be present, each being associated with a drawer name.

An additional feature is enabled through add password button 146. If the administrator has previously created a drawer but did not choose to create a password, the administrator can select add password button 146. The administrator will then be prompted to enter a password consisting of any set of alphanumeric characters. The system will store the password and only allow access to the information within the drawer upon successful entry of the password by the administrator or any other user.

FIG. 12 is a screen shot of user interface 150 associated with operations 134 and 136. User interface 150 includes name field 152, password field 154, and create drawer button 156. User interface 150 performs operation 134 by prompting the administrator for a drawer name. The administrator enters the drawer name into name field 152. User interface 150 also performs operation 136 by prompting the administrator for a drawer password. The administrator enters the password into password field 154. After entering the name and password, the administrator selects create drawer button 156 to initiate operation 138 in which the drawer is created that is associated with the name and password. A similar user interface (not shown in FIG. 12) will be presented to the administrator or representative on subsequent attempts to access the drawer. The user interface includes a password field similar to password field 154 and a button to submit the password for verification.

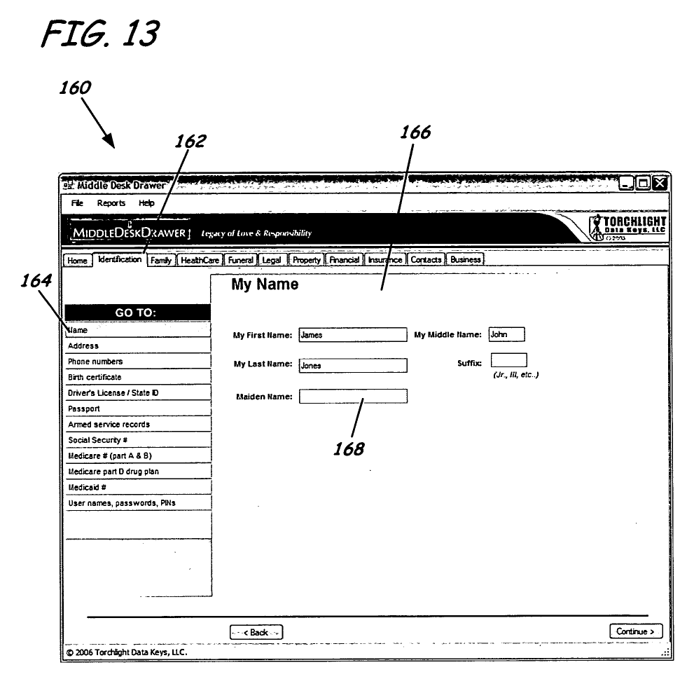

FIG. 13 is a screen shot illustrating one example of user interface 160 for managing information relating to the end-of-life issues of the administrator. After the administrator's drawer has been created or an existing drawer has been opened, a user interface such as user interface 160 is presented to the administrator or personal representative. User interface 160 includes folders 162, sub-folders 164, one or more pages 166, and one or more fields 168. The layout of user interface 160 enables the administrator or representative to quickly locate and manage information relating to the end-of-life issues of the administrator.

The information relating to the end-of-life issues of the administrator is categorized by user interface 160 in a plurality of folders. In the illustrated example, ten folders are shown, each folder relating to a particular topic. In FIG. 13, folder 162 labeled “Identification” is selected. The other folders are labeled family, health care, funeral, legal, property, financial, insurance, contacts, and business. These folders are just one example of the types and number of folders that could be used, and it is recognized that any number of folders could be used to categorize the information pertaining to the end-of-life issues of the administrator.

As an example, the identification folder 162 is used to manage end-of-life information pertaining to the identity of the administrator. Within each folder 162 is a plurality of sub-folders 164. Each sub-folder 164 relates to folder 162, but is a sub-category of folder 162. In the illustrated example, identification folder 162 includes twelve sub-folders 164 relating to the identification of the administrator. Sub-folders 164 include name, address, phone numbers, birth certificate, driver's license/state ID, passport, armed service records, Social Security number, Medicare number (part A and B), Medicare part D drug plan, Medicaid number, and user names, passwords, and PINs. In the same way, each folder 162 has a unique set of sub-folders 164 relating to the associated folder 162.

Each of sub-folders 164 include one or more pages 166 that contain fields 168. Pages 166 display information pertaining to the associated sub-folder 164. One or more fields 168 prompt the administrator to enter particular information associated with the particular sub-folder 164, and once entered, are also used to display the entered information. In the illustrated example, the name sub-folder 164 of identification folder 162 includes page 166 that displays information pertaining to the name of the administrator. A plurality of fields 168 prompt for and then subsequently display particular information relating to the name of the administrator. For example, fields 168 include first name, middle name, last name, suffix, and maiden name. Any other fields may also be presented that relate to folder 162 and sub-folder 164.

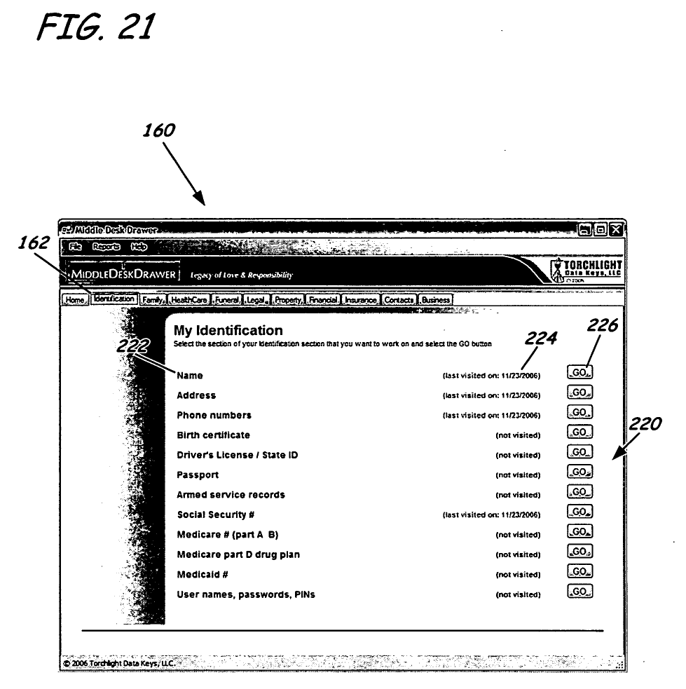

Many pages similar to page 166 exist within user interface 160, with one or more pages 166 each being associated with one folder 162 and one sub-folder 164. The administrator or the representative can easily navigate between folders 162, sub-folders 164, and pages 166 as desired to manage a particular set of information relating to end-of-life issues. One method of navigation is manual navigation in which the administrator or representative first selects the desired folder 162, then the desired sub-folder 164, the desired page 168, if multiple pages are associated with the sub-folder 164, and then selects or reviews the desired field or fields 168. Manual navigation is described in more detail below with reference to FIG. 21. Another example method of navigation is guided navigation, which is described below.

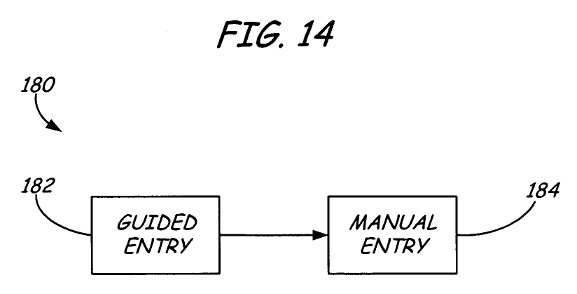

FIG. 14 is a flow chart illustrating method 180 in which the administrator enters data relating to end-of-life issues. After a drawer has been created, information relating to the end-of-life issues of the administrator needs to be entered. Multiple methods of entering data are provided, such as through the guided entry of operation 182 and the manual entry of operation 184. The guided entry of operation 182 is provided the first time a particular folder is accessed to assist the administrator in quickly selecting and entering relevant information. Following the guided entry of operation 182, manual entry 184 is subsequently provided for further data entry, or to review or otherwise manage information pertaining to the end-of-life issues of the administrator. Alternatively, the guided entry of operation 182 can be enabled at any time that the administrator wants it, such as by providing a guided entry button to initiate operation 182.

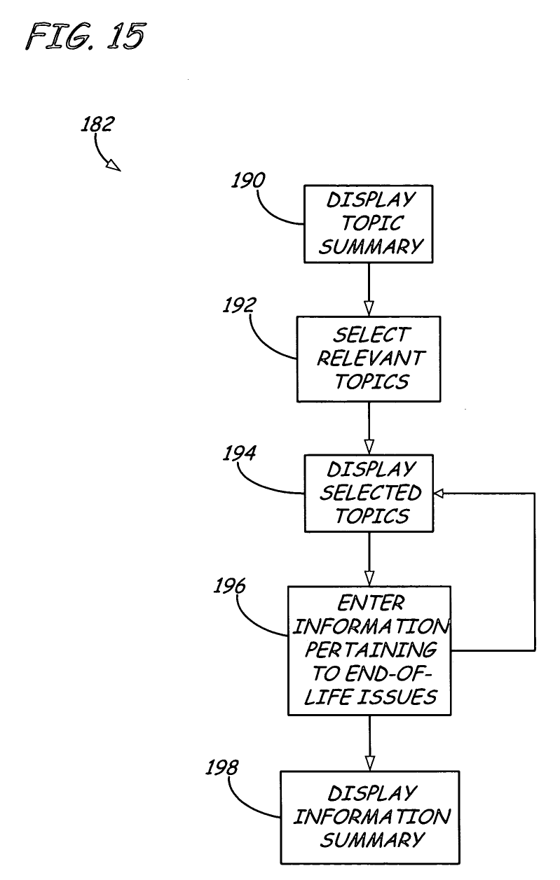

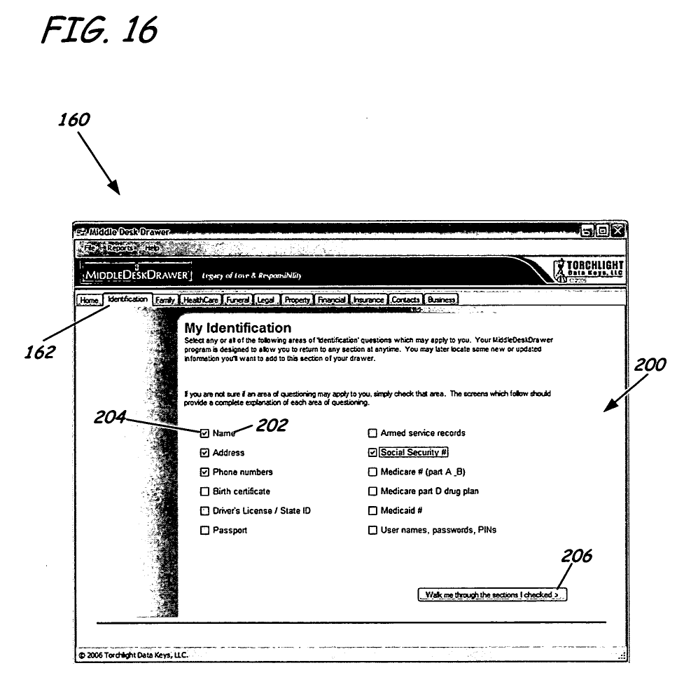

FIG. 15 is a flow chart illustrating the method of guided entry of operation 182 (shown in FIG. 14). Operation 182 includes operation 190 during which a topic summary is presented, operation 192 during which the administrator selects relevant topics, operation 194 during which pages associated with each selected topic are automatically and consecutively presented to the user, operation 196 during which data is entered into fields of each page presented, the data being information pertaining to the end-of-life issues of the administrator, and operation 198 during which an information summary is displayed. Each operation of operation 182 will now be described in more detail with reference to FIGS. 16-21.

FIG. 16 is a screen shot of user interface 160 displaying an example topic summary 200 as performed in operation 190 (shown in FIG. 15). Topic summary 200 includes topic display 202, topic selection box 204, and selection button 206. The first time that the administrator accesses one of folders 162, a topic summary page, such as topic summary 200, is displayed relating to the selected folder 162. For example, the first time that the administrator selects Identification folder 162, the “My Identification” topic summary 200 is displayed to the administrator.

Topic summary 200 includes one or more topic displays that correspond to folder 162. In the illustrated example, each of topic displays 202 corresponds directly to one of sub-folders (e.g., sub-folders 164 shown in FIG. 13). Specifically, the “Name” topic display 202 is presented in topic summary 200 which corresponds directly to the “Name” sub-folder (164 of FIG. 13). All other sub-folders are also displayed with an individual topic display 202.

Each topic display is also associated with a topic selection box 204. After topic summary 200 has been displayed, operation 192 is performed during which the administrator reads the list of available topics, and selects all of the topic selection boxes 204 that are relevant to the end-of-life information that the administrator desires to enter. In the illustrated example, the administrator selects four topic selection boxes 204 corresponding with the name, address, phone numbers, and social security number topic displays 202. The administrator then selects selection button 206 to proceed. In this example, all topics relating to unselected topic selection boxes 204 will be skipped, such that the administrator will not be guided through the entry of information relating to the unselected topics.

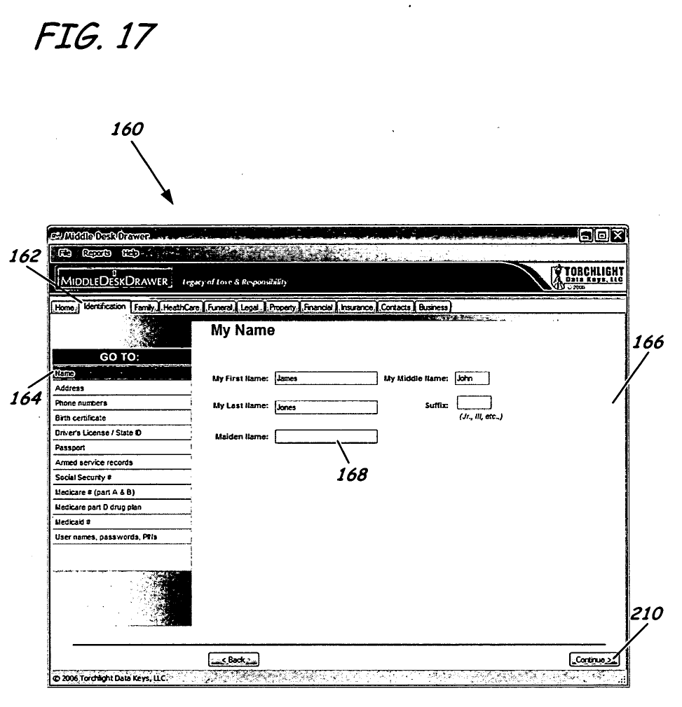

FIG. 17 is a screen shot of user interface 160 performing an example of operation 194 to display topics selected in operation 192. User interface 160 includes folders 162, sub-folders 164, page(s) 166, fields 168, and continue button 210.

In the illustrated example of FIG. 16, the first selected topic was “Name.” As a result, in operation 194 the “Name” topic is the first topic presented to the administrator.

The “Name” topic is associated with the “Name” sub-folder 164. Therefore the “Name” sub-folder 164 is automatically selected, as shown, and the corresponding page 166 is automatically displayed. Alternatively, the topic does not need to correspond directly with a sub-folder, and could instead guide the administrator to enter information anywhere within user interface 160, such as to enter data that will be stored in various folders and/or sub-folders.

In operation 196, the administrator then enters information pertaining to end-of-life issues, as desired into fields 168. In the illustrated example, the administrator enters his first name of “James,” middle name of “John,” and last name of “Jones.” The administrator may enter the appropriate information into any field that the administrator desires, and may also leave any field blank if desired. After all information on page 166 has been entered, the administrator selects continue button 210.

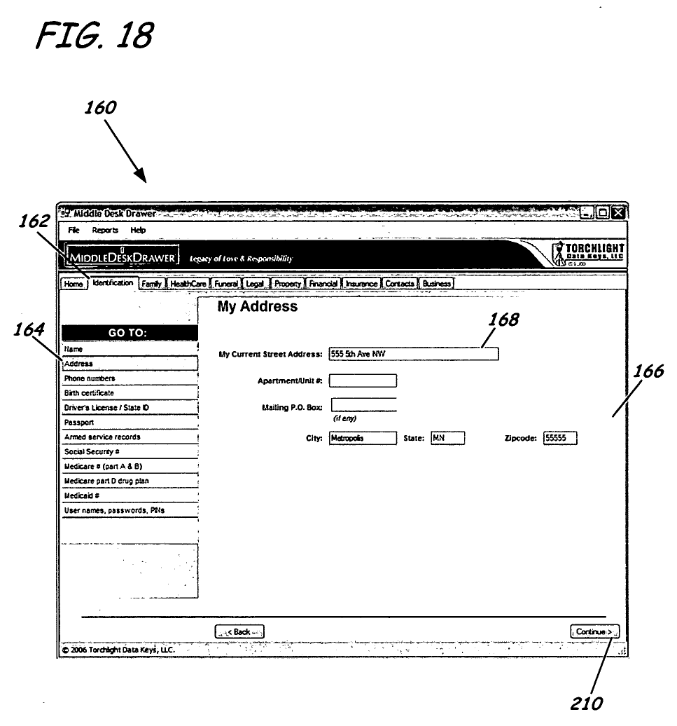

FIG. 18 is a screen shot of user interface 160 performing an example of operation 194 to display a second topic selected in operation 192. User interface 160 includes folders 162, sub-folder 164, page 166, fields 168, and continue button 210.

In the illustrated example of FIG. 16, the second selected topic was “Address.” Thus, after the administrator selects continue button 210 (of FIG. 17), the sub-folder 164 and page 166 associated with the “Address” topic are displayed. Address page 166 includes one or more fields in which the administrator can enter his address. Following operation 194, during which the selected topic is displayed, operation 196 is again performed by the administrator to enter the desired information. In the illustrated example, the administrator enters his street address, city, state, and zip code into the appropriate fields 168. The administrator also chooses to leave apartment number and mailing P.O. box blank, either because the administrator does not have them, or because the administrator does not want to enter the information. After operation 196 is complete, the administrator selects continue button 210 to proceed.

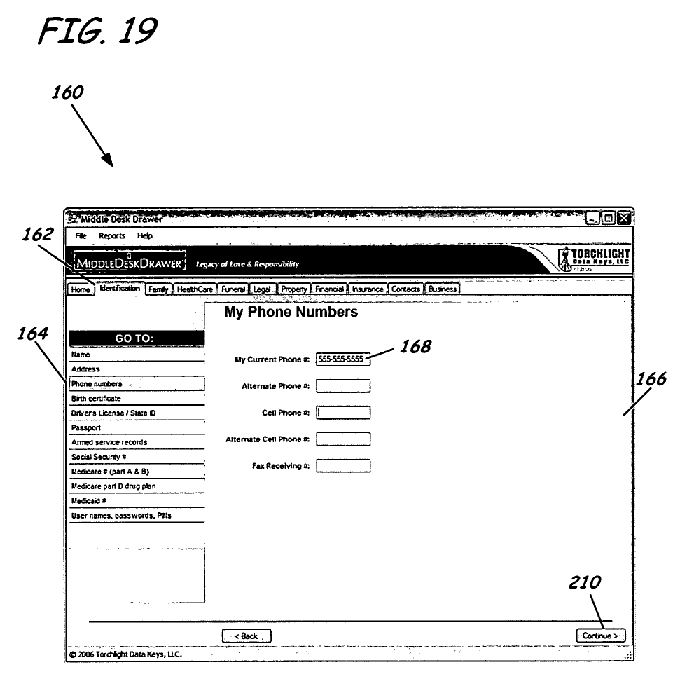

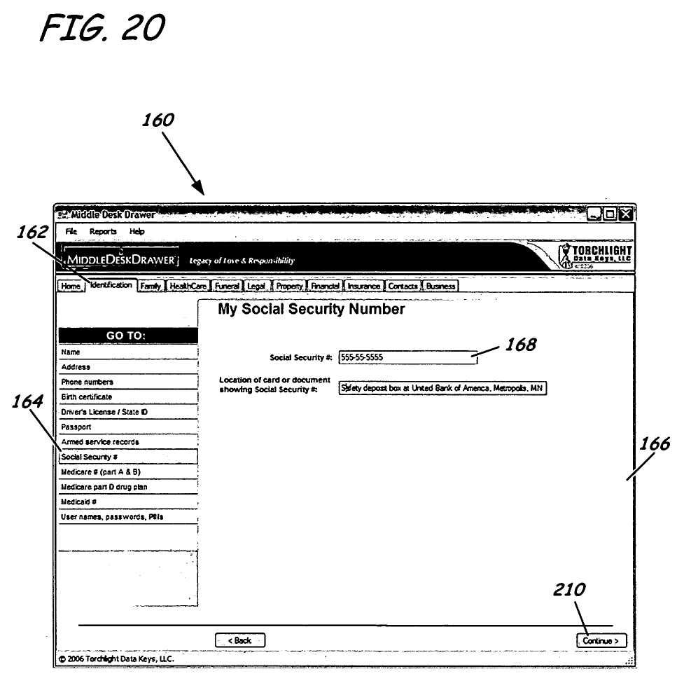

FIGS. 19 and 20 are screen shots of user interface 160 further illustrating operations 194 and 196. In FIG. 19, the sub-folder 164 and page 166 associated with the third topic selected in operation 192 are displayed, as in operation 194. Information is then entered by the administrator, as in operation 196. In this case, the information relates to the “Phone Number” topic. In FIG. 20, the fourth and final topic selected in operation 92 is displayed, relating to the “Social Security number” topic, as in operation 194. The related information is entered by the administrator, as in operation 196. In each case, the administrator selects continue button 200 to proceed.

FIG. 21 is a screen shot of user interface 160 illustrating an example information summary display 220, as in operation 198 (shown in FIG. 15). Information summary display 220 is displayed on user interface 160 after all selected topics have been displayed, as in operation 194, and any desired information has been entered by the administrator, as in operation 196.

Information summary 220 includes topic display 222, last visit display 224, and topic select button 226. All topics associated with the selected folder 162 are displayed with a topic display 222 in information summary 200, including those topics that were previously selected and those that were not selected. Each topic display 222 corresponds directly to one of sub-folders 164 as previously shown and described. Each topic display 222 has an associated last visit display 224 and a topic select button 226. Last visit display 224 displays the date at which the topic was last accessed by the administrator or another user.

Last visit display 224 provides a number of benefits. One of the benefits is that it allows the administrator to quickly determine the last time that information was updated within the associated topic. Another benefit is that the last visit display 224 can alert the administrator or other user if the information has been accessed by another without permission. For example, if the administrator last visited a topic a week ago, but the last visit date shows yesterday's date, the administrator is alerted that someone has accessed the information within the corresponding sub-folder. Another benefit is that a representative reviewing the end-of-life information can use the last visit display 224 to evaluate whether the information within the topic is up-to-date, or whether the administrator had allowed the information within the topic to become out-dated.

Information summary display 220 also includes topic select button 226. The administrator or the representative can select topic select button 226 to manage or review information relating to the associated topic. When topic select button 226 is selected, the current date and time is stored on storage medium 32 and associated with the related folder, and sub-folder. This information is used the next time that information summary display 220 is displayed to update the associated last visit display 224. Topic select button 226 will then cause user interface 160 to display the sub-folder and pages associated with that topic to enable the administrator or representative to view or manage the associated information.

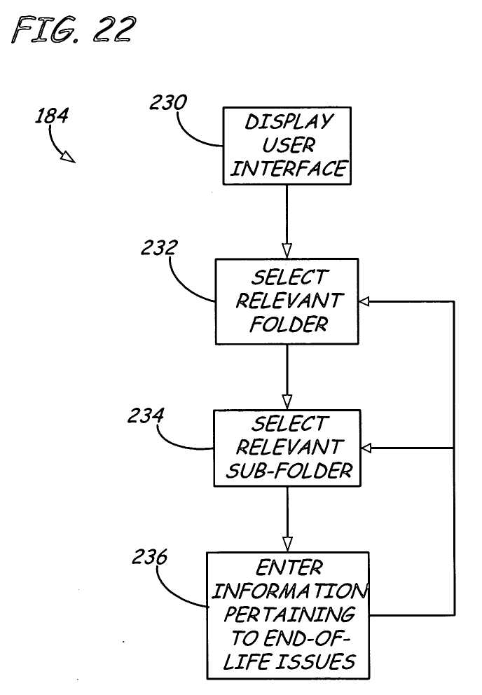

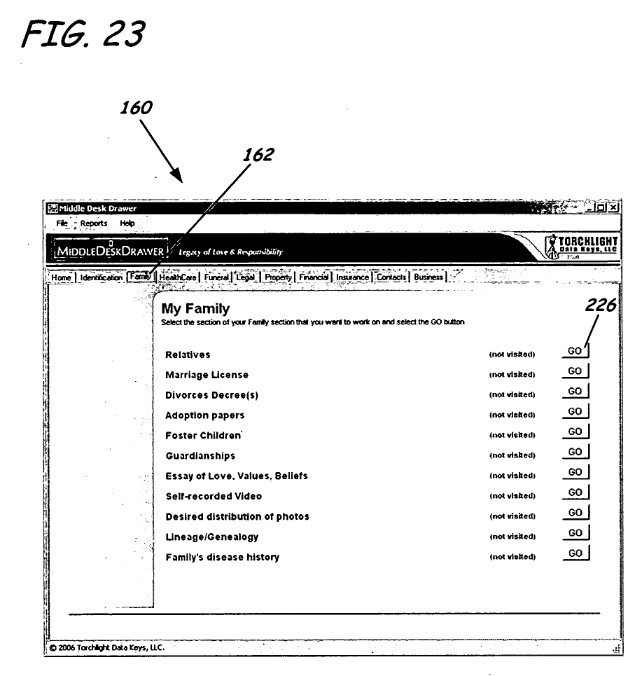

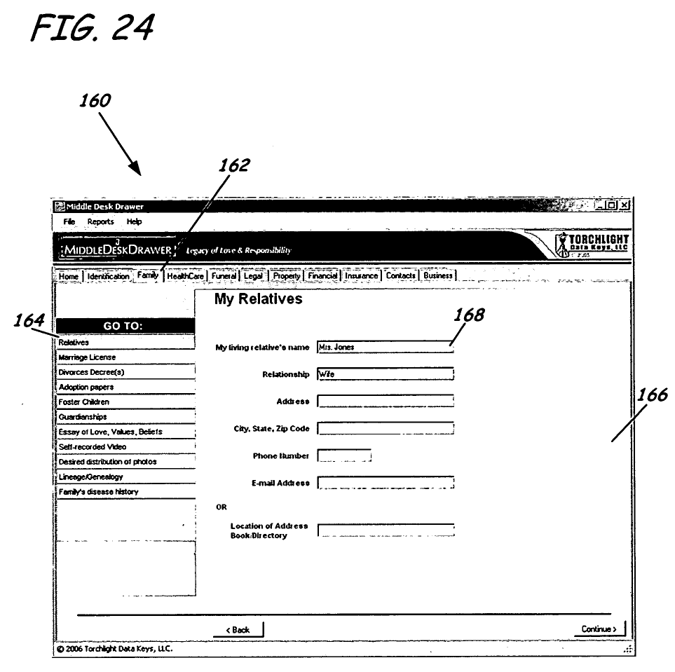

FIG. 22 is a flow chart illustrating the method of manual entry of operation 184 (shown in FIG. 14). Operation 184 includes operation 230 during which a user interface is displayed, operation 232 during which a relevant folder is selected, operation 234 during which a relevant sub-folder is selected, and operation 236 during which information pertaining to end-of-life issues is entered. Each operation of operation 184 will now be described in more detail with reference to FIGS. 23-24.

FIG. 23 is a screen shot of user interface 160 illustrating operations 230 and 232 of manual entry operation 184 (shown in FIG. 22). When the administrator desires to enter, review, or otherwise manage information pertaining to end-of-life issues, the administrator can choose to do so manually, such as through manual entry operation 184. Operation 184, as illustrated in FIG. 22, first begins with operation 230 during which user interface 160 is displayed. User interface 160 will always be present after the administrator has opened the administrator's drawer, but may be displaying any of a variety of pages, summaries, or other displays.

Operation 232 is then performed, during which the administrator selects a folder relating to the information that the administrator desires to enter. In the illustrated example, the administrator desires to enter information about his wife who is currently living. To do so, he reviews the folders that are available, and determines that the “Family” folder 162 is most relevant to information about his wife. Therefore, the administrator selects “Family” folder 162, which causes information summary display 220 to be presented on user interface 160, as shown.

Operation 234 is then performed, after the user interface is displayed, during which the administrator selects a sub-folder relating to the information that the administrator desires to enter. In the illustrated example, the administrator reviews the available topics, and selects the “Relatives” sub-folder, by selecting the topic select button 226 associated with the “Relatives” topic. The user interface is then updated as shown in FIG. 24.

FIG. 24 is a screen shot of user interface 160 displaying an example page 166 for the performance of operation 236. After operation 234 (shown in FIG. 22) has been completed by the selection of a relevant sub-folder, operation 236 is performed during which information pertaining to the end-of-life issues of the administrator is entered, reviewed, or otherwise managed. In the illustrated example, the “My Relatives” page 166 associated with the selected “relatives” sub-folder 164 is displayed. The “My Relatives” page includes one or more fields in which the administrator can enter information relating to his relatives, such as information about his wife who is still living, as in operation 236.

Note that FIG. 24 also illustrates an alternative to operation 234, previously described with reference to FIG. 23, wherein the relevant sub-folder is selected. In this alternative, the administrator or representative can select sub-folder 164 directly from the side bar, rather than selecting the topic select button. For example, if the administrator now desired to enter information about his foster children, the administrator could select the “Foster Children” sub-folder 164 to be presented with the related “Foster Children” page 166, not shown in FIG. 24.

Therefore, as can be seen from the above illustrated examples, both guided navigation and manual navigation are provided. Guided navigation, such as through guided entry operation 182, is beneficial when an administrator has a lot of information to enter, and wants to be guided through the relevant pages. It enables the administrator to select what topics of information the administrator wants to enter as well as what topics of information the administrator does not want to enter. User interface 160 then automatically guides the administrator through a consecutive series of pages relating to the selected topics while skipping the unselected topics. On the other hand, manual navigation, such as through manual entry operation 184, is beneficial when an administrator has specific and small amounts of information that the administrator wants to enter, update, review, or otherwise manage.

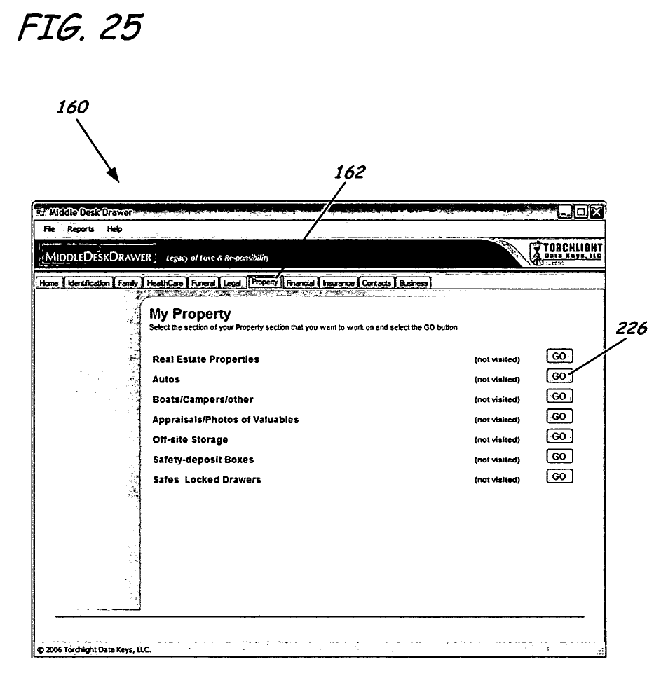

FIGS. 25-30 illustrate a method by which pages can be dynamically added to a sub-folder to enable records to be stored when a variable number of items or entries are needed. To illustrate this, an example is provided wherein the administrator desires to enter information relating to his automobiles. Because a person can have any number of automobiles, it is desirable to enable the administrator to enter information for as many automobiles as he has. As a result, the system dynamically creates pages within the sub-folder for each automobile he owns.

FIG. 25 is a screen shot of user interface 160 with the property folder 162 selected. The administrator selects property folder 162 because he wants to enter information about his personal property, namely his automobiles. The administrator then selects the topic select button 226 corresponding to the Autos topic, to select the desired sub-folder.

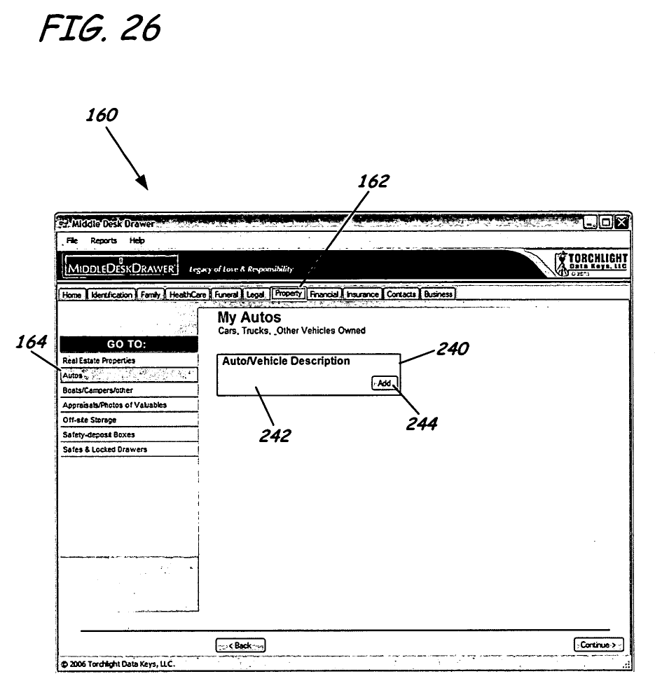

FIG. 26 is a screen shot of an example user interface 160 having the Autos sub-folder 164 selected, and illustrating an example dynamic information box 240. Dynamic information box 240 includes dynamic data display 242 and add button 244. In the illustrated example, no information about automobiles has been entered yet, and therefore dynamic information box 240 contains no information about the administrator's automobiles. To add this information, the administrator selects add button 244.

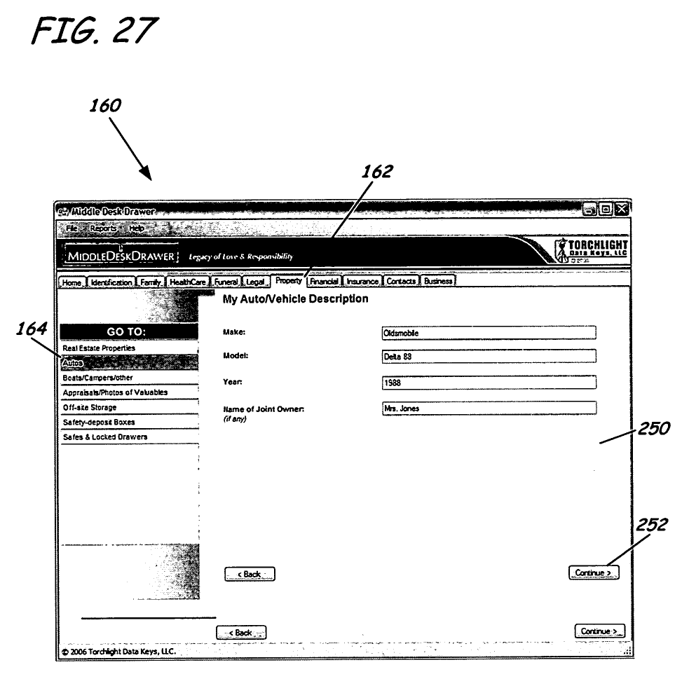

FIG. 27 is a screen shot of an example user interface 160 including dynamic page 250. Dynamic page 250 is dynamic because any number of pages can be created, depending on the number of items or records needed. For example, each of the administrator's cars will have its own dynamic page 250, in which information about the administrator's cars or other vehicles can be stored. The administrator can enter information about the first automobile into dynamic page 250, such as the make, model, year, and name of a joint owner. The administrator then selects the continue button 252 to proceed.

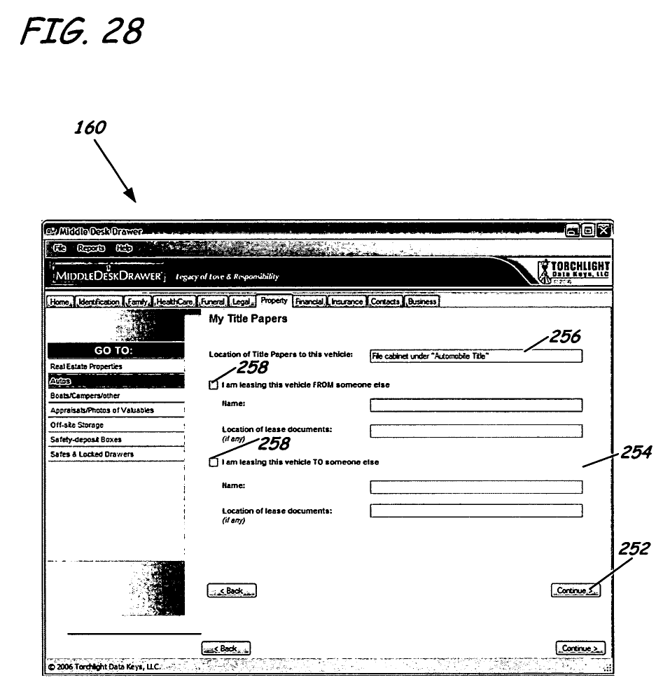

FIG. 28 is a screen shot of an example user interface 160 including another dynamic page 254. In this example, dynamic page 254 is displayed after the administrator selects continue button 252 on dynamic page 250 (shown in FIG. 27). Dynamic page 254 includes fields 256 and check boxes 258, through which the administrator can enter further information pertaining to the title papers of his automobile. After the information has been entered, the administrator selects continue button 252 to proceed.

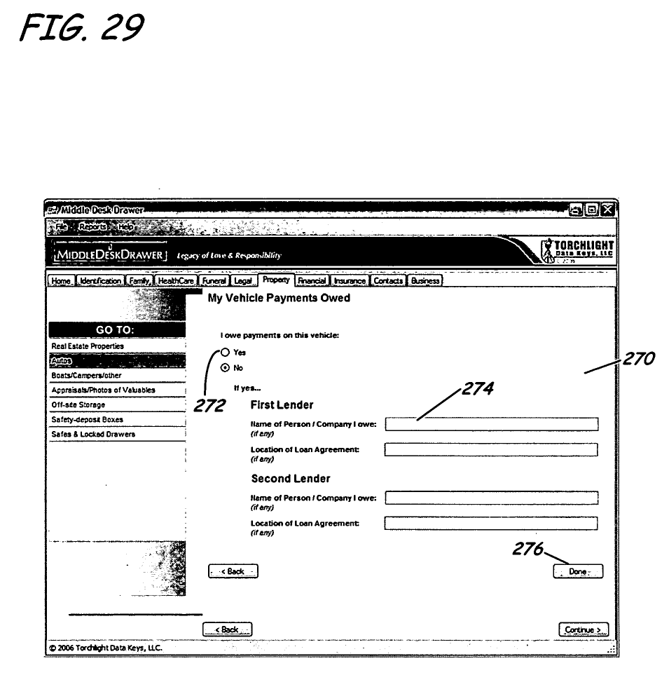

FIG. 29 is a screen shot of example user interface 160 including another dynamic page 270. In this example, dynamic page 270 is displayed after the administrator has completed entering information into dynamic page 254. Dynamic page 270 includes radio buttons 272 and fields 274, through which the administrator can enter further information pertaining to the payments owed on the automobile. After the information has been entered, the administrator selects done button 276 to complete the entering of information about his automobile.

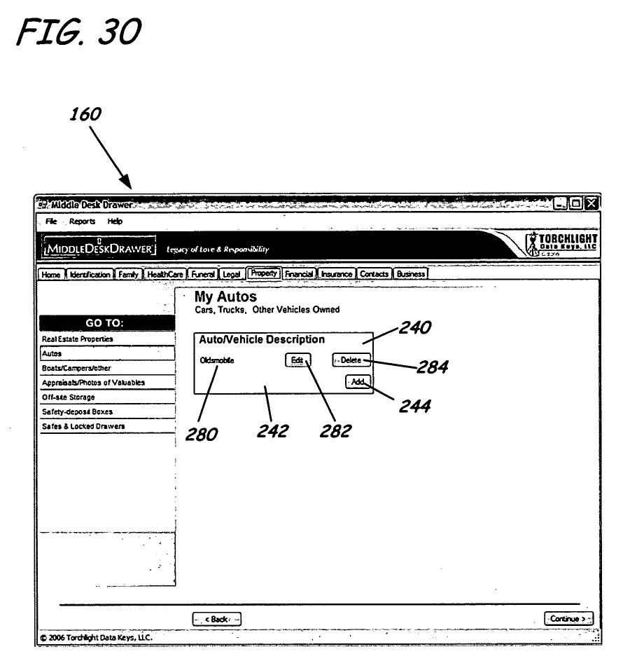

FIG. 30 is a screen shot of an example user interface 160 including dynamic information box 240. After information about an automobile has been entered, dynamic information box 240 changes to display the name of the automobile that has been entered. Dynamic information box 240 still contains dynamic data display 242 and add button 244. In addition, however, dynamic information box 240 now also includes first automobile name 282, edit button 284, and delete button 286.

From this point, the administrator has a number of options. He may edit the information entered, by selecting edit button 282, which will then present him again with dynamic pages 250, 254, and 270 to enable the administrator to edit or otherwise manage the information relating to that automobile. He may also delete the information, such as if he sells the car and no longer owns it, by selecting delete button 284.

In addition, the administrator may also add information relating to additional automobiles that he owns or rents, by selecting add button 244. After selecting add button 244, the administrator is presented with a new set of dynamic pages 250, 254, and 270 in which to enter the information for the additional automobile. When completed, the name of the additional automobile will also be listed in dynamic information box 240, below the previously entered automobile name (assuming the previously entered automobile information has not been previously deleted by the administrator). In this way, the system enables the administrator to enter an endless number of automobiles, or any other information relating to the end-of-life issues of the administrator, by using dynamic pages such as 250, 254, and 270.

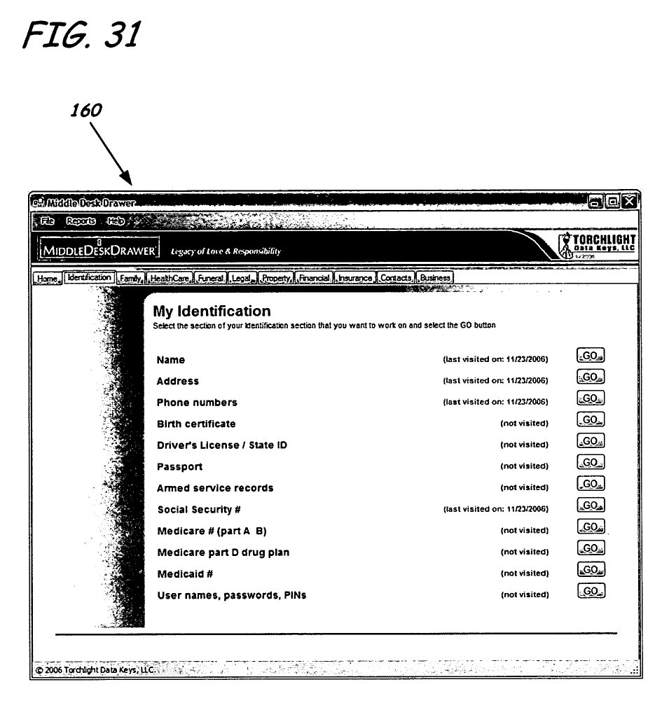

FIGS. 31-40 illustrate an example of the types of information that can be stored within the system. It is recognized that any information relating to the end-of-life issues of the administrator can be entered and managed, but these figures are provided to illustrate one example of the folders and sub-folders that could be provided to organize the information for the administrator and the representative. The topics listed below are also the same as the sub-folders that could be included within the respective folder within each sub-folder are pages having fields in which the administrator can store information relating to the specific topic.

FIG. 31 is a screen shot of user interface 160 with the Identification folder of folders 162 selected. The identification folder can be used to store information about the identity of the administrator. Information contained within this folder includes name; address; phone numbers; birth certificate; drivers license/state ID; passport; armed service records; social security number; Medicare number (part A B); Medicare part D drug plan; Medicaid number; and user names, passwords, and PINs.

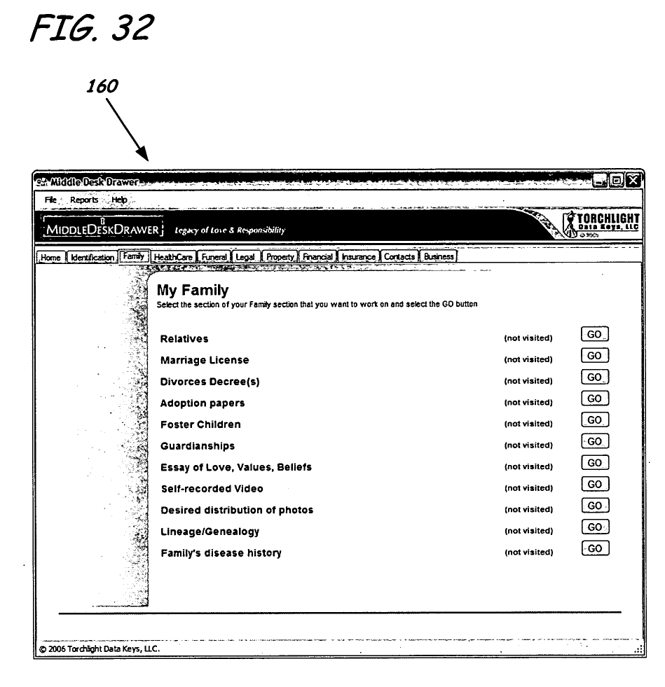

FIG. 32 is a screen shot of user interface 160 with the Family folder of folders 162 selected. The Family folder can be used to store information about the family of the administrator. The information contained within this folder includes relatives; marriage license; divorce decree(s); adoption papers; foster children; guardianships; essay of love, values, and beliefs; self-recorded video; desired distribution of photos; lineage/genealogy; and family's disease history.

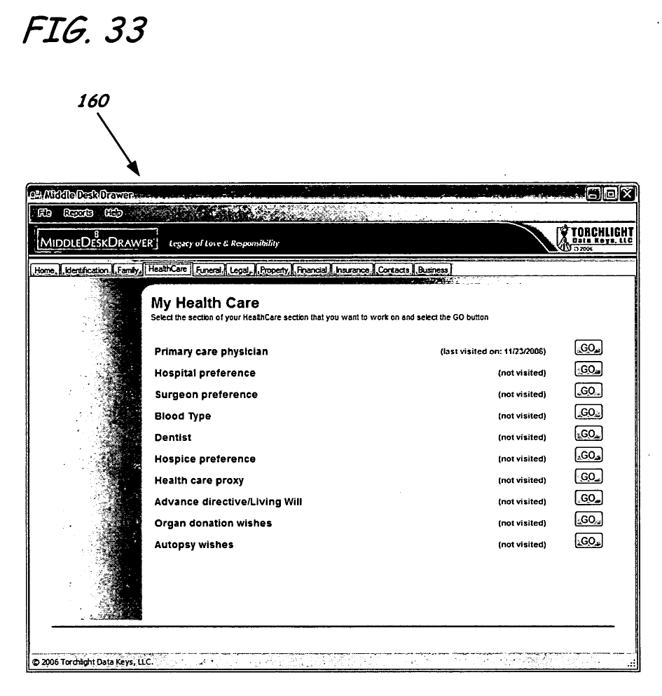

FIG. 33 is a screen shot of user interface 160 with the Health Care folder of folders 162 selected. The Health Care folder can be used to store information about the past or present health care, or the future desires for health care, of the administrator. The information contained within this folder includes primary care physician, hospital preference, surgeon preference, blood type, dentist, hospice preference, health care proxy, advance directive/living will, organ donation wishes, and autopsy wishes.

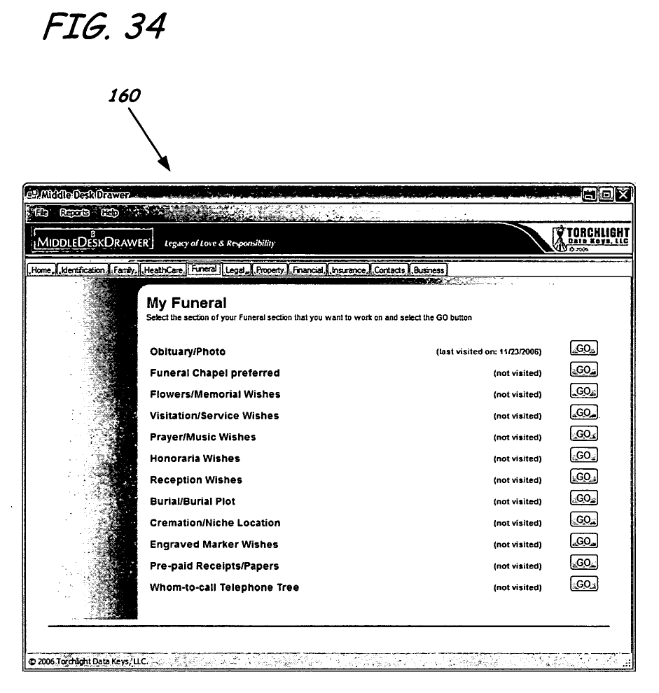

FIG. 34 is a screen shot of user interface 160 with the Funeral folder of folders 162 selected. The Funeral folder can be used to store information about the funeral desires of the administrator. The information contained within this folder includes obituary/photo, funeral chapel preferred, flowers/memorial wishes, visitation/service wishes, prayer/music wishes, honoraria wishes, reception wishes, burial/burial plot, cremation/niche location, engraved marker wishes, pre-paid receipts/papers, and whom-to-call telephone tree.

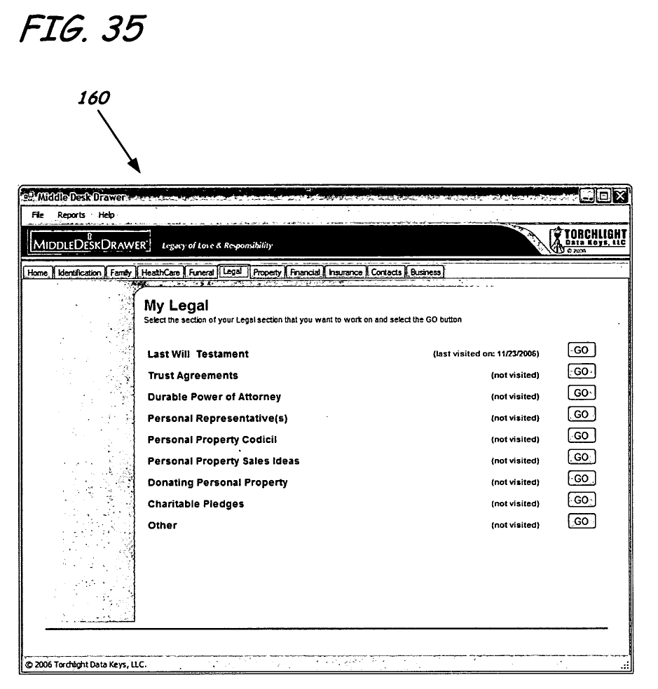

FIG. 35 is a screen shot of user interface 160 with the Legal folder of folders 162 selected. The Legal folder can be used to store information about the funeral desires of the administrator. The information contained within this folder includes last will and testament, trust agreements, durable power of attorney, personal representative(s), personal property codicil, personal property sales ideas, donating personal property, charitable pledges, and other legal information.

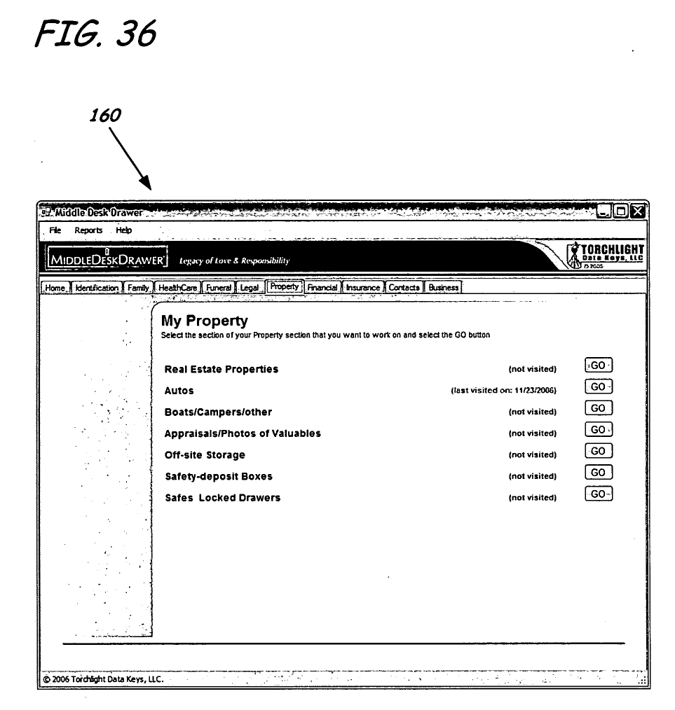

FIG. 36 is a screen shot of user interface 160 with the Property folder of folders 162 selected. The Property folder can be used to store information about the real and personal property owned or used by the administrator. The information contained within this folder includes real estate properties, boats/campers/other, appraisals/photos of valuables, off-site storage, safety-deposit boxes, and safes and locked drawers.

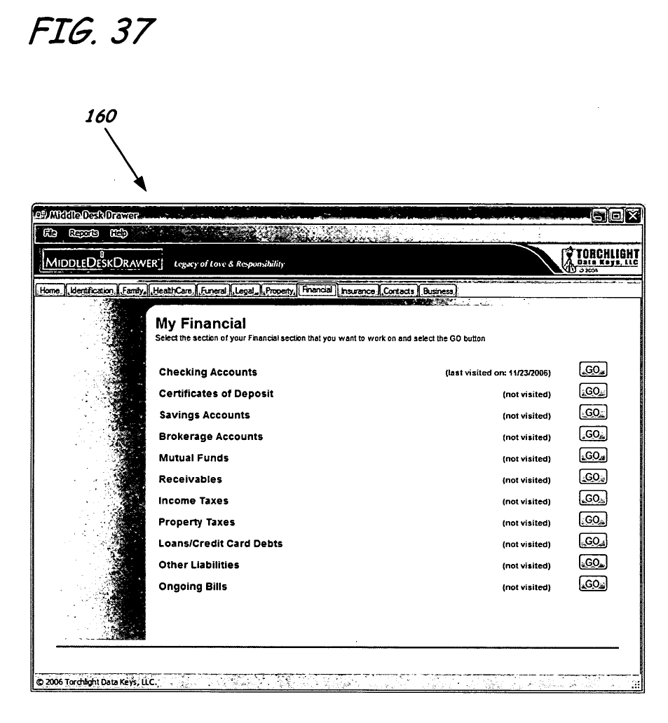

FIG. 37 is a screen shot of user interface 160 with the Financial folder of folders 162 selected. The Financial folder can be used to store financial information relating to the administrator. The information contained within this folder includes checking accounts, certificates of deposit, savings accounts, brokerage accounts, mutual funds, receivables, income taxes, property taxes, loans/credit card debts, other liabilities, and ongoing bills.

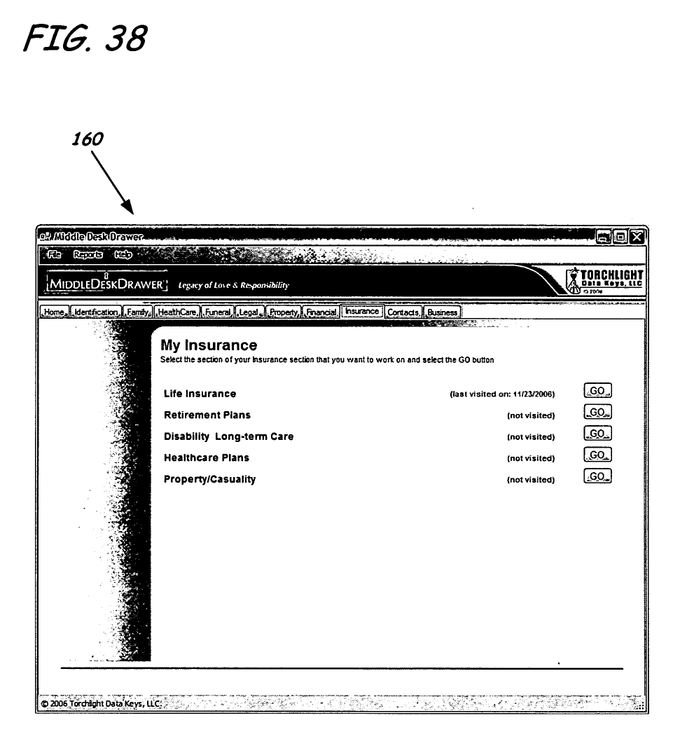

FIG. 38 is a screen shot of user interface 160 with the Insurance folder of folders 162 selected. The Insurance folder can be used to store information about insurance owned or associated with the administrator. The information contained within this folder includes life insurance, retirement plans, disability and long-term care, healthcare plans, and property/casualty.

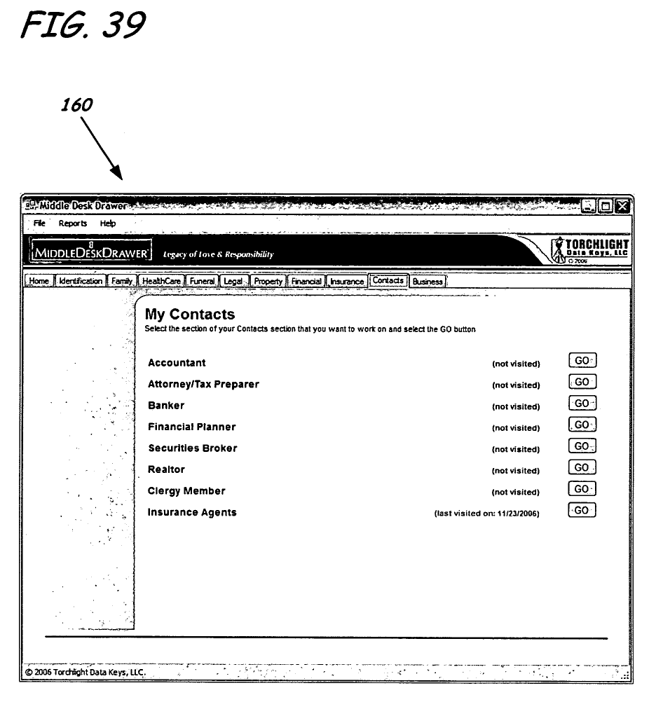

FIG. 39 is a screen shot of user interface 160 with the Contacts folder of folders 162 selected. The Contacts folder can be used to store information about the personal and professional contacts of the administrator. Information contained within this folder includes accountant, attorney/tax preparer, banker, financial planner, securities broker, realtor, clergy member, and insurance agents.

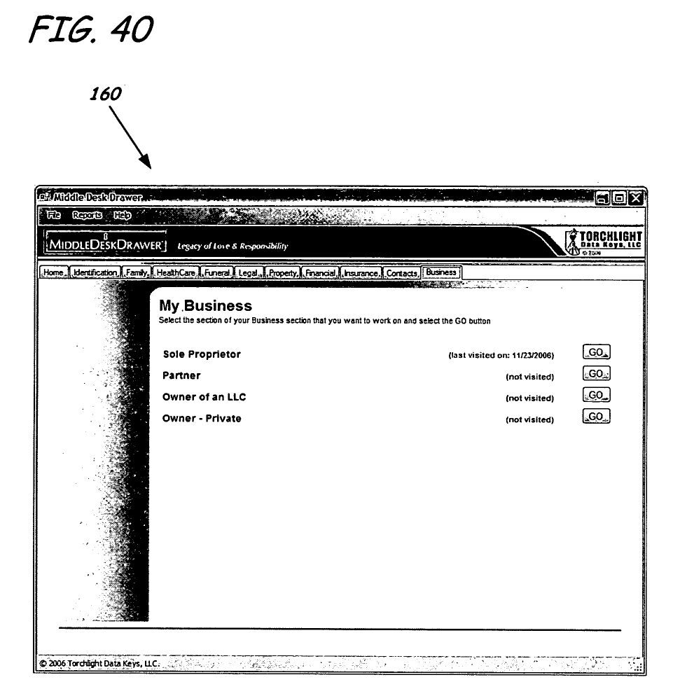

FIG. 40 is a screen shot of user interface 160 with the Business folder of folders 162 selected. The Business folder can be used to store information about any businesses that the administrator owns or is involved with. Information contained within this folder includes sole proprietor, partner, owner of an LLC, and owner-private.

After the administrator has entered and maintained the information relating to the end-of-life issues of the administrator, at some point the preparation period 42 (shown in FIG. 2) will come to an end and the end-of-life period 44 (also shown in FIG. 2) will begin, such as after the death or incapacitation of the administrator. During end-of-life period 44, the representative accesses the administrator's drawer by opening the existing drawer (after operation 132 shown in FIG. 10), and entering the password, if any (after operation 142 of FIG. 10). The representative is then allowed access to user interface 160 described above to print or otherwise review the stored information. In this way, the representative is greatly aided in the task of resolving the end-of-life issues of the administrator because all, or much, of the information needed is provided to the representative in the single location of the system described herein.

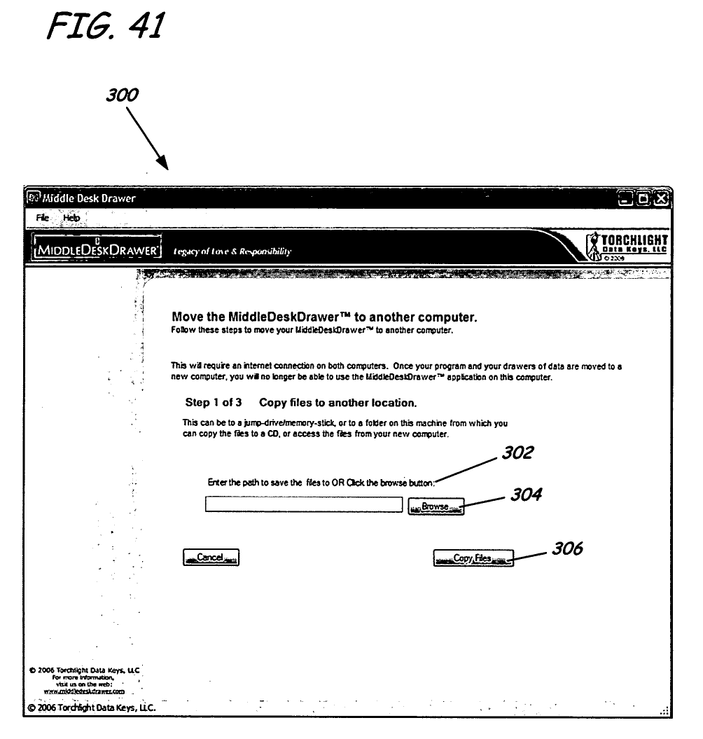

FIG. 41 is a screen shot of user interface 300 for transferring software from one device to another device. After installation and unlocking of software 24 (e.g., FIG. 1) has been completed, product 12 can be discarded because all necessary information is now stored on device 14. The installation and unlocking operations need not be repeated after the first installation. Should the administrator desire to transfer software 24 (e.g., FIG. 1) to a different device, software 24 can be copied to the new device and uninstalled from device 14.

To do so, user interface 300 is used. User interface 300 is used to perform three steps. The first step, shown in FIG. 41, is performed after the user has indicated a desire to move the software 24 to another device (such as another computing system). In addition to software 24, user files are also transferred to preserve end-of-life information that has already been entered. Such a desire is input by the user, such as by selecting “File” and “Move to Another Computer.” User interface 300 is then displayed.

User interface 300 guides the user through the process. First, user interface 300 displays prompt 302 which requests from the user an input identifying a file path where the software 24 and end-of-life information should be temporarily stored. The file path can be a form of removable memory (e.g., a disc, Compact Disc, jump-drive/memory-stick. The file can also be a storage location on the device or on another device, such as across a network. Button 304 is a browse button. If the user does not immediately know the path to the desired location, button 304 is selected. User interface 300 then displays a menu from which the location can be selected by the user. The user then selects button 306 to copy the files to the identified location.

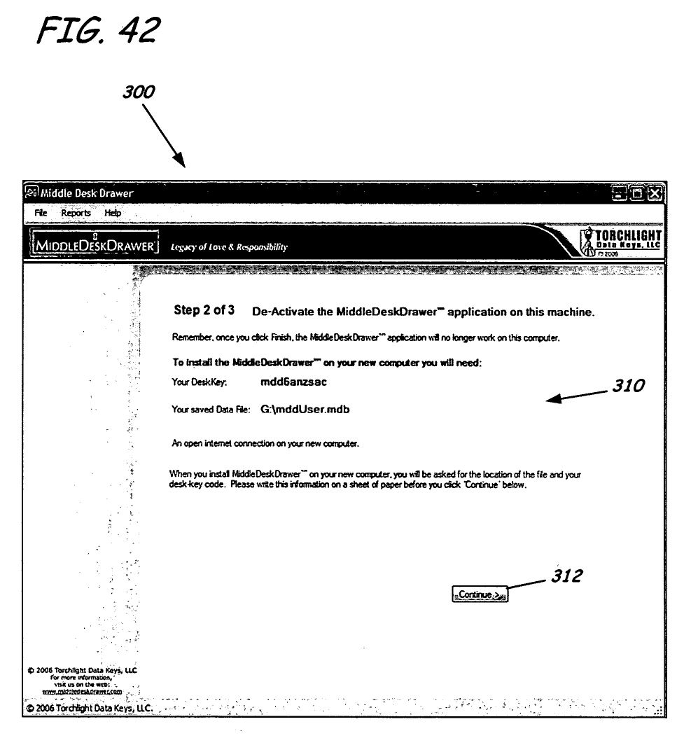

FIG. 42 is a screen shot of user interface 300 displaying a second step of transferring software from one device to another device. After software 24 and end-of-life information have been copied to the temporary location, user interface 300 displays a second step. In this step, software 24 is deactivated on the device in preparation for activation on another device. To do so, message 310 is displayed to inform the user that software 24 will be deactivated, and that a connection to the Internet (or other communication network) is required. In addition, message 310 displays the product key code and the location in which the software was temporarily stored. Message 310 asks the user to make a note of this information for subsequent use. Button 312 is displayed on user interface 300. The user selects button 312 to continue deactivation. When button 312 is selected, the software communicated with the key verification server (e.g., 36 of server 18 shown in FIG. 1) and informs the server that the software has been deactivated on device 14. Key verification 36 updates database 40 accordingly to note that the product key code is again available for use, because the software is no longer installed on a device. Software 24 is also updated to lock features of software 24 from use.

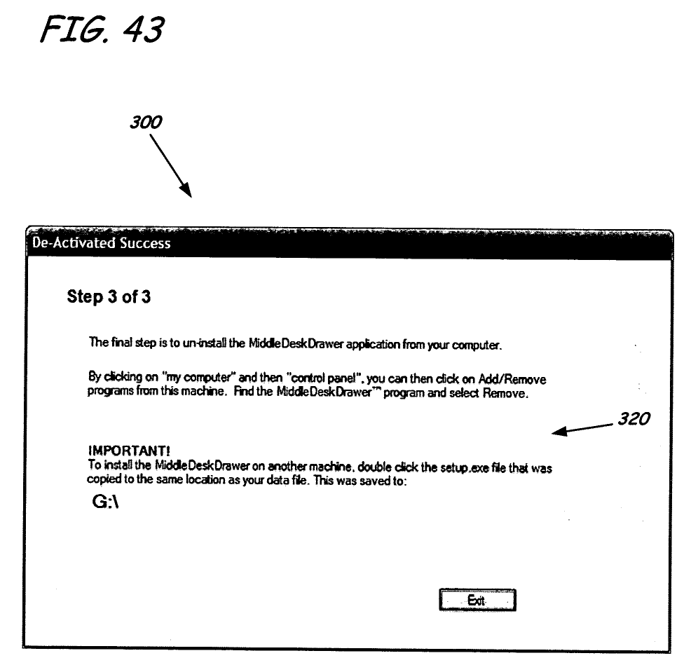

FIG. 43 is a screen shot of user interface 300 displaying a third step of uninstalling software 24 from device 14. User interface 300 includes message 320. Message 320 instructs the user to use the operating system uninstall application to remove software 24 from device 14. Message 320 also instructs the user to run the software installation program on the new device to install software 24 at the new location.

After software 24 has been uninstalled from device 14, the user then installs the software and end-of-life information onto another device, as desired, from the temporary storage location. When prompted, the user enters the product key code provided in step 2 (FIG. 42). Installation and unlocking is performed as described with reference to FIGS. 3-7 above.

This shows that the software and end-of-life information can be copied to another device without the need for product 12 or product key code 22, which are only needed for a first installation of the software. As a result, the software and end-of-life information are portable between devices.

It is noted that not all of the features characterized herein need to be incorporated within a given arrangement, for the arrangement to include improvements according to the present disclosure.

What is claimed is:

1. A system for managing information relating to end-of-life issues of an administrator, the system comprising:
a computer readable storage medium;
a product key code associated with the computer readable storage medium, the product key code including alphanumeric characters; and
packaging containing the computer readable storage medium and the product key code, the packaging obscuring the product key code from view until the packaging is opened;
wherein the computer readable storage medium stores computer-executable instructions which when executed by a computer cause the computer to perform a method of managing information relating to end-of-life issues, the method comprising:
receiving the product key code;
communicating across a network with a server to validate the product key code;
unlocking features of the computer-executable instructions after validating;
prompting for and receiving end-of-life information after unlocking; and
storing the end-of-life information after receiving.

2. The system of claim 1, wherein prompting for and receiving end-of-life information comprises operating in a guided entry mode and operating in a manual entry mode.

3. The system of claim 2, wherein operating in a guided entry mode comprises:
displaying a list of available topics;
receiving an input identifying some of the available topics;
sequentially prompting for and receiving information relating to the identified topics; and
displaying a summary of the information relating to the identified topics after sequentially prompting for and receiving information relating to the identified topics.

4. The system of claim 2, wherein operating in a manual entry mode comprises:
displaying a list of topics;
receiving an input identifying one of the topics;
displaying a list of sub-topics associated with the identified topic;
receiving an input identifying one of the sub-topics; and
prompting for and receiving information relating to the sub-topic.

5. The system of claim 2, wherein operating in the guided entry mode occurs before operating in the manual entry mode.

6. The system of claim 1, wherein prompting for and receiving end-of-life information comprises displaying a number of dynamic information boxes, the number being defined by user input.

7. The system of claim 6, wherein prompting for and receiving end-of-life information further comprises displaying a number of dynamic pages, the number of dynamic pages being defined by user input.

8. The system of claim 1, further comprising displaying a summary page, the summary page including a list of topics and a date of last visit associated with each of the topics, the date of last visit identifying the most recent date that information associated with the respective topic was displayed, if any.

9. The system of claim 1, wherein the method further comprises:
locking features of the computer-executable instructions;
copying the computer-executable instructions and the end-of-life information for subsequent installation on another system; and
communicating across the network with the server to inform the server that the features have been locked and to reactivate the product key code such that the product key code is available for subsequent use by another system.

10. The system of claim 1, wherein the method of managing information relating to end-of-life issues further comprises:
receiving an input requesting a transfer of the computer-executable instructions and the end-of-life information to a second computing system;
prompting a user for a temporary storage location for the computer-executable instructions and the end-of-life information;
storing the computer-executable instructions and the end-of-life information at the temporary storage location;
communicating across the network with the server to inform of the transfer; and
displaying instructions for uninstalling the computer-executable instructions from the system.

11. The system of claim 10, wherein informing of the transfer comprises informing the server that features of the computer-executable instructions have been locked on the system.
